(19) United States
(12) Patent Application Publication
(10) Pub. No.: US 2007/0265787 A1
(43) Pub. Date: Nov. 15, 2007

(54) Computational methods and systems for magnifying cell-mediated immune response

(75) Inventors: Mahalaxmi Gita Bangera, Renton, WA (US); Muriel Y. Ishikawa, Livermore, CA (US); Edward K.Y. Jung, Bellevue, WA (US); Nathan P. Myhrvold, Medina, WA (US); Elizabeth A. Sweeney, Seattle, WA (US); Richa Wilson, San Francisco, CA (US); Lowell L. Wood JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC,a limited liability corporation of the State of Delaware

(21) Appl. No.: 11/807,332

(22) Filed: May 25, 2007

Related U.S. Application Data
(63) Continuation-in-part of application No. 10/925,902, filed on Aug. 24, 2004.

(51) Int. Cl. G06F 19/00

(52) U.S. Cl. 702/19

(57) ABSTRACT

The present application relates, in general, to a system and/or method related to detection and/or treatment.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

1. For purposes of the USPTO extra-statutory requirements, the present application constitutes a continuation in part of currently co-pending United States patent application entitled A SYSTEM AND METHOD RELATED TO ENHANCING AN IMMUNE SYSTEM naming MURIEL Y. ISHIKAWA, EDWARD K. Y. JUNG, NATHAN P. MYHRVOLD, RICHA WILSON, AND LOWELL L. WOOD, JR. as inventors, filed Aug. 24, 2004 having U.S. application Ser. No. 10/925,902.

2. For purposes of the USPTO extra-statutory requirements, the present application constitutes a continuation-in-part of currently co-pending United States parent application entitled A SYSTEM AND METHOD RELATED TO IMPROVING AN IMMUNE SYSTEM naming MURIEL Y. ISHIKAWA, EDWARD K. Y. JUNG, NATHAN P. MYHRVOLD, RICHA WILSON, and LOWELL L. WOOD, JR. as inventors, filed Aug. 24, 2004 having U.S. application Ser. No. 10/925,904.

3. For purposes of the USPTO extra-statutory requirements, the present application constitutes a continuation in part of currently co-pending United States patent application entitled A SYSTEM AND METHOD RELATED TO AUGMENTING AN IMMUNE SYSTEM naming MURIEL Y. ISHIKAWA, EDWARD K. Y. JUNG, NATHAN P. MYHRVOLD, RICHA WILSON, AND LOWELL L. WOOD, JR. as inventors, filed Aug. 24, 2004 having U.S. application Ser. No. 10/925,905.

4. For purposes of the USPTO extra-statutory requirements, the present application constitutes a continuation in part of currently co-pending United States patent application entitled A SYSTEM AND METHOD FOR MAGNIFYING AN IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Aug. 25, 2004 having U.S. application Ser. No. 10/926,753.

5. For purposes of the USPTO extra-statutory requirements, the present application constitutes a continuation in part of currently co-pending United States patent application entitled A SYSTEM AND METHOD FOR HEIGHTENING AN IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Aug. 25, 2004 having U.S. application Ser. No. 10/926,881.

6. For purposes of the USPTO extra-statutory requirements, the present application constitutes a continuation in part of currently co-pending United States patent application entitled A SYSTEM AND METHOD FOR MODULATING A HUMORAL IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Dec. 1, 2004 having U.S. application Ser. No. 11/001,259.

7. For purposes of the USPTO extra-statutory requirements, the present application constitutes a continuation in part of currently co-pending United States patent application entitled A SYSTEM AND METHOD FOR HEIGHTENING A HUMORAL IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Dec. 3, 2004 having U.S. application Ser. No. 11,004,419.

8. For purposes of the USPTO extra-statutory requirements, the present application constitutes a continuation in part of currently co-pending United States patent application entitled A SYSTEM AND METHOD FOR AUGMENTING A HUMORAL IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Dec. 3, 2004 having U.S. application Ser. No. 11/004,446.

9. For purposes of the USPTO extra-statutory requirements, the present application constitutes a continuation in part of currently co-pending United States patent application entitled A SYSTEM AND METHOD FOR IMPROVING A HUMORAL IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Jan. 26, 2005 having U.S. application Ser. No. 11/044,656.

10. For purposes of the USPTO extra-statutory requirements, the present application constitutes a continuation in part of currently co-pending United States patent application entitled A SYSTEM AND METHOD FOR MAGNIFYING A HUMORAL IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Jan. 28, 2005 having U.S. application Ser. No. 11/046,658.

11. For purposes of the USPTO extra-statutory requirements, the present application constitutes a continuation in part of currently co-pending United States patent application entitled A SYSTEM AND METHOD FOR MAGNIFYING A HUMORAL IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed May 16, 2005 having U.S. application Ser. No. 11/131,155.

12. For purposes of the USPTO extra-statutory requirements, the present application constitutes a continuation in part of currently co-pending United States patent application entitled A SYSTEM AND METHOD FOR MODULATING A CELL MEDIATED IMMUNE RESPONSE naming MURIEL Y. ISHIKAWA, EDWARD K. Y. JUNG, NATHAN P. MYHRVOLD, RICHA WILSON, AND LOWELL L. WOOD, JR. as inventors, filed Aug. 26, 2005 having U.S. application Ser. No. 11/213,325.

13. For purposes of the USPTO extra-statutory requirements, the present application constitutes a continuation in part of currently co-pending United States patent application entitled COMPUTATIONAL SYSTEMS AND METHODS RELATING TO AMELIORATING AN IMMUNE SYSTEM naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed Mar. 14, 2007 having U.S. application Ser. No. 11/724,580.

14. For purposes of the USPTO extra-statutory requirements, the present application constitutes a continuation in part of currently co-pending United States patent application entitled COMPUTATIONAL SYSTEMS AND METHODS RELATING TO FORTIFYING AN IMMUNE SYSTEM naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed Mar. 14, 2007 having U.S. application Ser. No. 11/724,593.

15. For purposes of the USPTO extra-statutory requirements, the present application constitutes a continuation in part of currently co-pending United States patent application entitled COMPUTATIONAL METHODS AND SYSTEMS TO REINFORCE A HUMORAL IMMUNE RESPONSE naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed Mar. 26, 2007 having U.S. application Ser. No. 11/728,950.

16. For purposes of the USPTO extra-statutory requirements, the present application constitutes a continuation in part of currently co-pending United States patent application entitled COMPUTATIONAL METHODS AND SYSTEMS TO BOLSTER A HUMORAL IMMUNE RESPONSE naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed Mar. 28, 2007 having U.S. application Ser. No. 11/729,958.

17. For purposes of the USPTO extra-statutory requirements, the present application constitutes a continuation in part of currently co-pending United States patent application entitled COMPUTATIONAL METHODS AND SYSTEMS TO ADJUST A HUMORAL IMMUNE RESPONSE naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed Mar. 28, 2007 having U.S. application Ser. No. 11/731,001.

18. For purposes of the USPTO extra-statutory requirements, the present application constitutes a continuation in part of currently co-pending United States patent application entitled COMPUTATIONAL METHODS AND SYSTEMS FOR AUGMENTING CELL-MEDIATED IMMUNE RESPONSE naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed May 25, 2007 having U.S. application Ser. No. ______ [To Be Assigned by the USPTO].

19. For purposes of the USPTO extra-statutory requirements, the present application constitutes a continuation in part of currently co-pending United States patent application entitled COMPUTATIONAL METHODS AND SYSTEMS FOR IMPROVING CELL-MEDIATED IMMUNE RESPONSE naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed May 25, 2007 having U.S. application Ser. No. ______ [To Be Assigned by the USPTO].

20. For purposes of the USPTO extra-statutory requirements, the present application constitutes a continuation in part of currently co-pending United States patent application entitled COMPUTATIONAL METHODS AND SYSTEMS FOR HEIGHTENING CELL-MEDIATED IMMUNE RESPONSE naming MAHALAXMI GITA BANGERA, MURIEL Y. ISHIKAWA, EDWARD K. Y. JUNG, NATHAN P. MYHRVOLD, ELIZABETH A. SWEENEY, RICHA WILSON, AND LOWELL L. WOOD, JR. as inventors, filed May 25, 2007 having U.S. application Ser. No. ______ [To Be Assigned by the USPTO].

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

In one aspect, a system includes at least one computer program for use with at least one computer system and wherein the at least one computer program includes a plurality of instructions, including but not limited to, one or more instructions for suggesting at least one treatment option for at least one host, wherein the at least one treatment option is associated with modulating a predicted pattern of progression of one or more computable epitopes. In addition to the foregoing, other system aspects are described in the claims, drawings, and text forming a part of the present disclosure.

In one aspect, a system includes but is not limited to circuitry for suggesting at least one treatment option for at least one host, wherein the at least one treatment option is associated with modulating a predicted pattern of progression of one or more computable epitopes. In addition to the foregoing, other system aspects are described in the claims, drawings, and text forming a part of the present disclosure. In one aspect, a method includes but is not limited to suggesting at least one treatment option for at least one host, wherein the at least one treatment option is associated with modulating a predicted pattern of progression of one or more computable epitopes. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In addition to the foregoing, various other method and/or system and/or program product aspects are set forth and described in the teachings such as text (e.g., claims and/or detailed description) and/or drawings of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 depicts some aspects of a system that may serve as an illustrative environment for subject matter technologies.

FIG. 2 depicts some aspects of a system that may serve as an illustrative environment for subject matter technologies.

FIG. 3 illustrates aspects of a system, such as those depicted in FIGS. 1 and 2.

FIG. 4 shows aspects of a system, such as those depicted in FIGS. 1 and 2.

FIG. 5 depicts aspects of a system, such as those depicted in FIGS. 1 and 2.

FIG. 6 illustrates aspects of a system, such as those depicted in FIGS. 1 and 2.

FIG. 7 depicts some aspects of a system that may serve as an illustrative environment for subject matter technologies.

FIG. 8 illustrates aspects of a system, such as that depicted in FIG. 7.

FIG. 9 shows aspects of a system, such as that depicted in FIG. 7.

FIG. 10 depicts aspects of a system, such as that depicted in FIG. 7.

FIG. 11 illustrates aspects of a system, such as that depicted in FIG. 7.

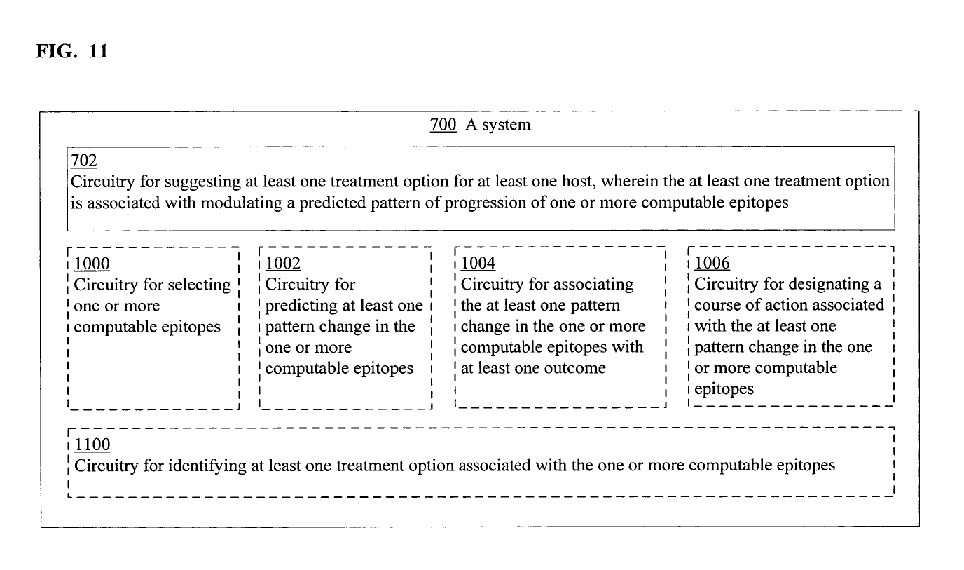

FIG. 12 depicts a diagrammatic view of some aspects of an exemplary interaction of an immune response component.

FIG. 13 shows a diagrammatic view of some aspects of enhancing an immune response.

FIG. 14 depicts some aspects of antigen-antibody interactions showing the occurrence of mutational changes in at least one epitope and corresponding changes in at least one antibody.

FIG. 15 illustrates some aspects of mutational changes in an epitope displayed by an agent and the corresponding changes in an immune response component.

FIG. 16 shows some aspects of cell mediated immune response.

FIG. 17 depicts some aspects of cell mediated immune response.

FIG. 18 illustrates some aspects of cell mediated immune response.

FIG. 19 depicts a diagrammatic view of antigenic shift.

FIG. 20 shows a logic flow chart of a process.

FIG. 21 illustrates a logic flowchart depicting alternate implementations of the logic flowchart of FIG. 20.

FIG. 22 shows a logic flowchart depicting alternate implementations of the logic flowchart of FIG. 20.

FIG. 23 shows a logic flowchart depicting alternate implementations of the logic flowchart of FIG. 20.

FIG. 24 shows a logic flowchart depicting alternate implementations of the logic flowchart of FIG. 20.

The use of the same symbols in different drawings typically indicates similar or identical items.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

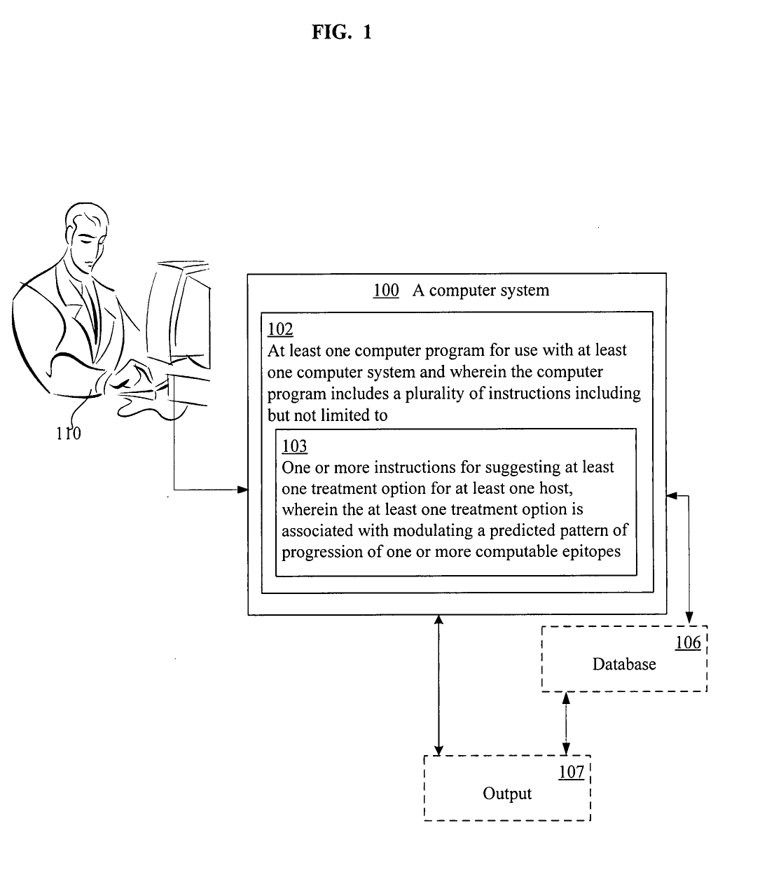

With reference to the figures, and with reference now to FIG. 1, depicted is one aspect of a system that may serve as an illustrative environment of and/or for subject matter technologies, for example, a computer-based method for designating one or more computable epitopes including at least one pattern change for modulating an agent or at least a part of an agent. Accordingly, the present application first describes certain specific exemplary systems of FIG. 1; thereafter, the present application illustrates certain specific exemplary structures and processes. Those having skill in the art will appreciate that the specific structures and processes described herein are intended as merely illustrative of their more general counterparts.

A. Structure(s) and or System(s)

Continuing to refer to FIG. 1, depicted is a partial view of a system that may serve as an illustrative environment of and/or for subject matter technologies. One or more users 110 may use at least one computer system 100 including at least one computer program for use with at least one computer system 102, wherein the at least one computer program 102 includes a plurality of instructions. The at least one computer program 102 may include one or more instructions for suggesting at least one treatment option for at least one host, wherein the at least one treatment option is associated with modulating a predicted pattern of progression of one or more computable epitopes 103, for example, computable epitopes associated with an agent, a disease, and/or a condition. A user interface may be coupled to provide access to the at least one computer program 102. In some implementations, the at least one computer program 102 may access at least one database 106 for storing information and transmit at least one output 107 to the computer system 100. In one exemplary implementation, a feedback loop is set up between the at least one computer program 102 and the at least one database 106. The at least one output 107 may be fed back into the at least one computer program 102 and/or displayed on the computer system 100. The system may be used as a research tool, as a tool for furthering treatment or the like. A feedback approach may be useful in an iterative process.

Although user 110 is shown/described herein as a single illustrated figure, those skilled in the art will appreciate that user 110 may be representative of a human user, a robotic user (e.g., computational entity), and/or substantially any combination thereof (e.g., a user may be assisted by one or more robotic agents). In addition, user 100, as set forth herein, although shown as a single entity may in fact be composed of two or more entities.

The instructions of the at least one computer program 102 may be such that, when they are loaded to a general purpose computer or microprocessor programmed to carry out the instructions, they create a new machine, because a general purpose computer in effect may become a special purpose computer once it is programmed to perform particular functions pursuant to instructions from program software. That is, the instructions of the software program may electrically change the general purpose computer by creating electrical paths within the device, and these electrical paths, in some implementations, may create a special purpose machine having circuitry for carrying out the particular program.

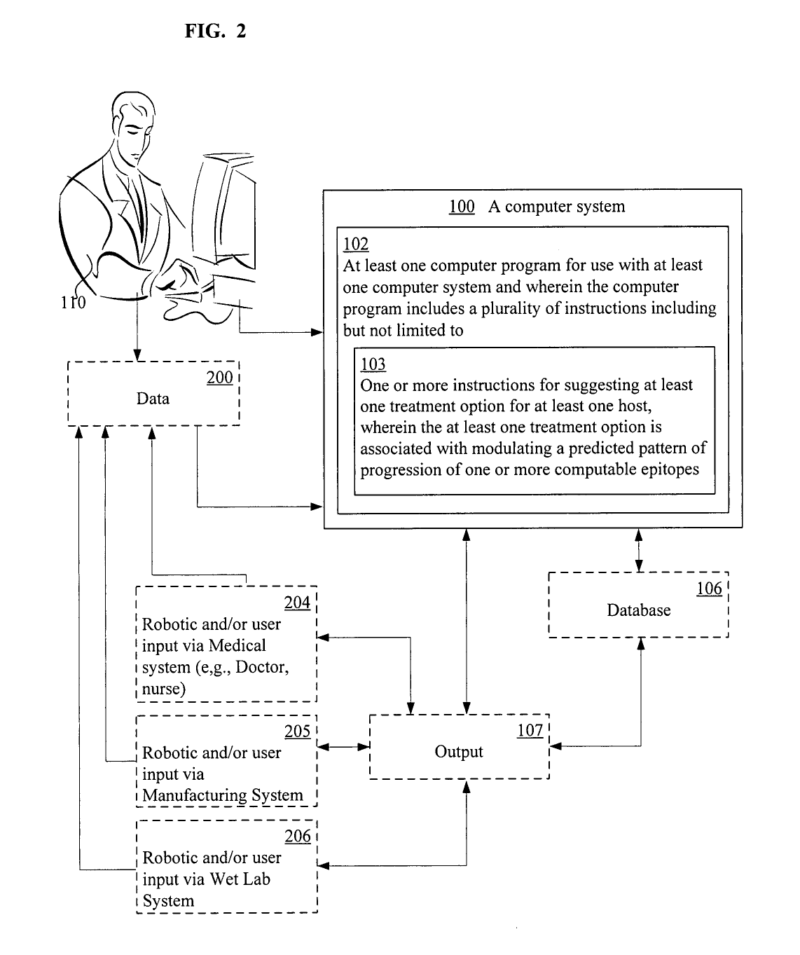

With reference to the figures, and with reference now to FIG. 2, depicted is a partial view of a system that may serve as an illustrative environment of and/or for subject matter technologies. The at least one computer program 102 may accept input from one or more users 110, for example, from medical personnel, research personnel, or wet lab personnel. The database 106, data 200, and/or the output 107 may be accessed by various interface mechanisms, for example, mechanisms including but not limited to, robotic and/or user interface via medical system 204, robotic and/or user interface via manufacturing system 205, or robotic and/or user interface via wet lab system 206. Access to the data 200 may be provided, for example, for further manipulation and/or analysis of the data.

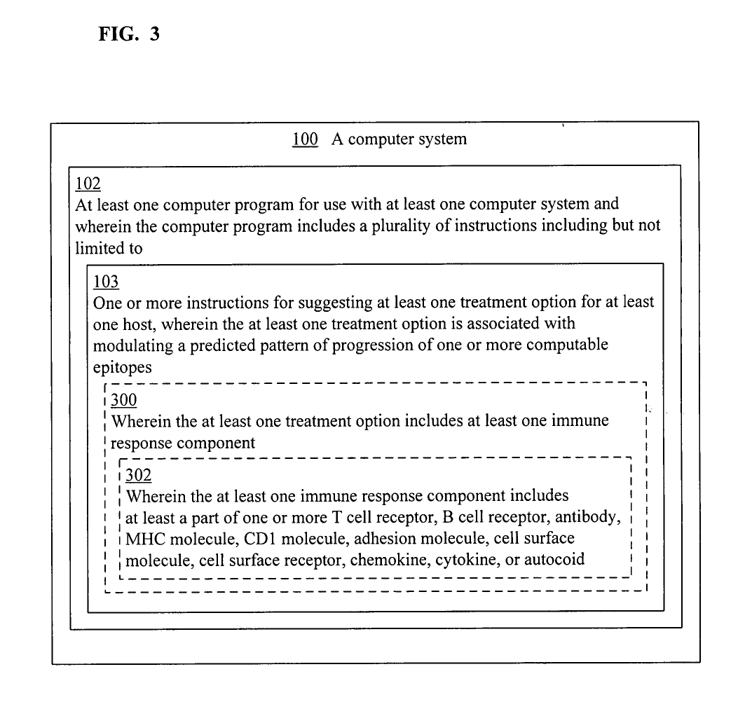

FIG. 3 depicts some exemplary aspects of a system such as that described in FIGS. 1 and 2. A computer system 100 may include at least one computer program for use with at least one computer system 102, where the computer program includes a plurality of instructions. The at least one computer program 102 may include one or more instructions for suggesting at least one treatment option for at least one host, wherein the at least one treatment option is associated with modulating a predicted pattern of progression of one or more computable epitopes 103. The one or more instructions 103 may include instructions wherein the at least one treatment option includes at least one immune response component 300. The instructions wherein the at least one treatment option includes at least one immune response component 300 may include instructions wherein the at least one immune response component includes at least a part of one or more T cell receptor, B cell receptor, antibody, MHC molecule, CD1 molecule, adhesion molecule, cell surface molecule, cell surface receptor, chemokine, cytokine, or autocoid 302.

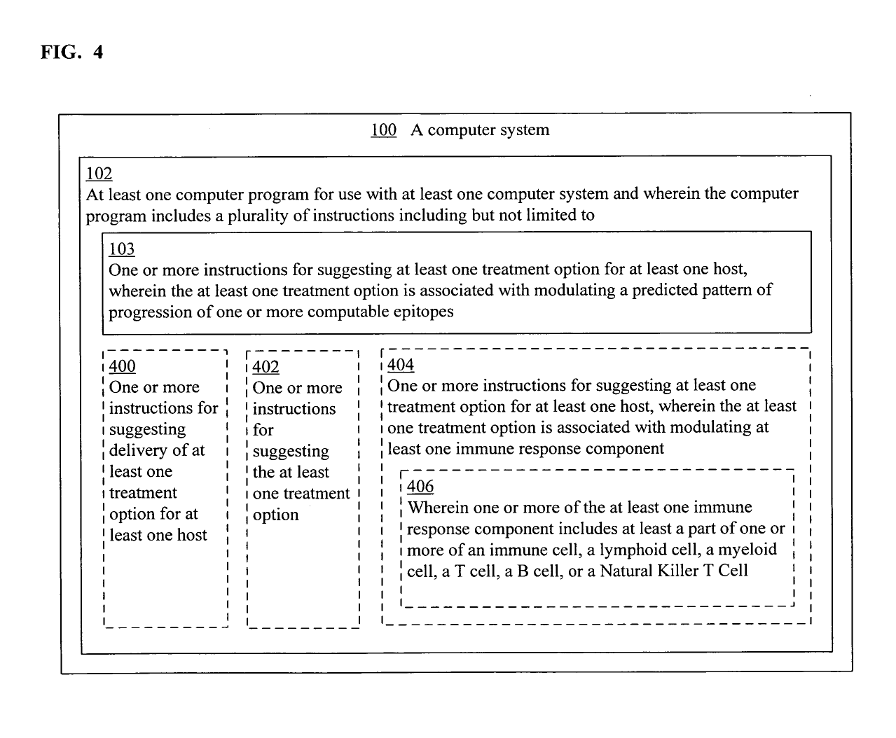

FIG. 4 illustrates some exemplary aspects of a system such as that described in FIGS. 1 and 2. A computer system 100 may include at least one computer program for use with at least one computer system 102, where the computer program includes a plurality of instructions. The at least one computer program 102 may include one or more instructions for suggesting at least one treatment option for at least one host, wherein the at least one treatment option is associated with modulating a predicted pattern of progression of one or more computable epitopes 103. The at least one computer program 102 may include one or more instructions for suggesting delivery of at least one treatment option for at least one host 400. The at least one computer program 102 may include one or more instructions for suggesting the at least one treatment option 402. The at least one computer program 102 may include one or more instructions for suggesting at least one treatment option for at least one host, wherein the at least one treatment option is associated with modulating at least one immune response component 404. The instructions 404 may include instructions wherein one or more of the at least one immune response component includes at least a part of one or more of an immune cell, a lymphoid cell, a myeloid cell, a T cell, a B cell, or a Natural Killer T Cell 406.

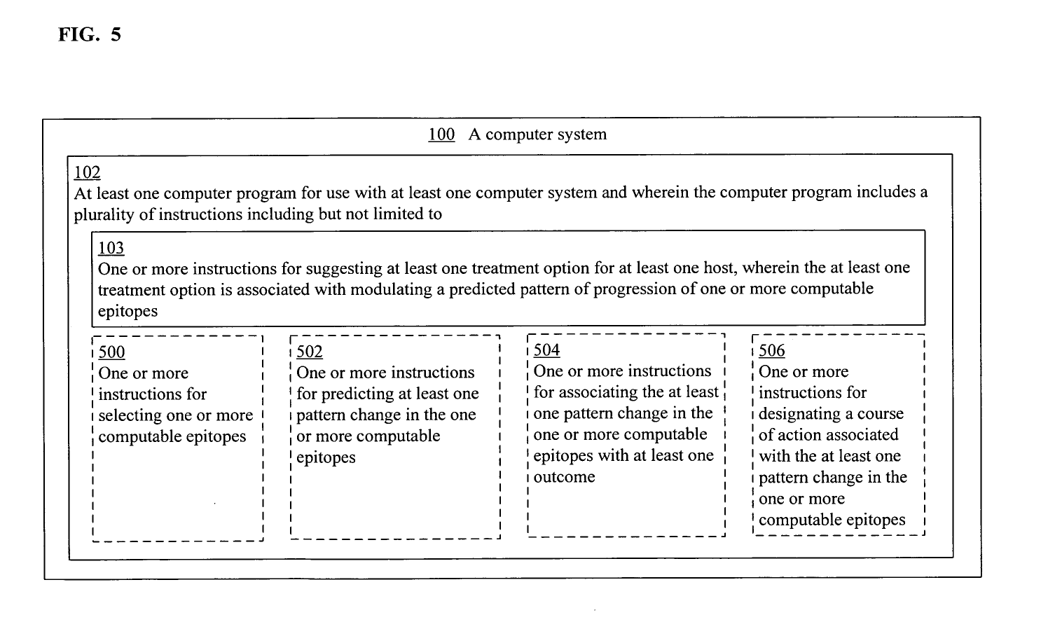

FIG. 5 depicts some exemplary aspects of a system such as that described in FIGS. 1 and 2. A computer system 100 may include at least one computer program for use with at least one computer system 102, where the computer program includes a plurality of instructions. The at least one computer program 102 may include one or more instructions for suggesting at least one treatment option for at least one host, wherein the at least one treatment option is associated with modulating a predicted pattern of progression of one or more computable epitopes 103. The at least one computer program 102 may include one or more instructions for selecting one or more computable epitopes 500. The at least one computer program 102 may include one or more instructions for predicting at least one pattern change in the one or more computable epitopes 502. The at least one computer program 102 may include one or more instructions for associating the at least one pattern change in the one or more computable epitopes with at least one outcome 504. The at least one computer program 102 may include one or more instructions for designating a course of action associated with the at least one pattern change in the one or more computable epitopes 506.

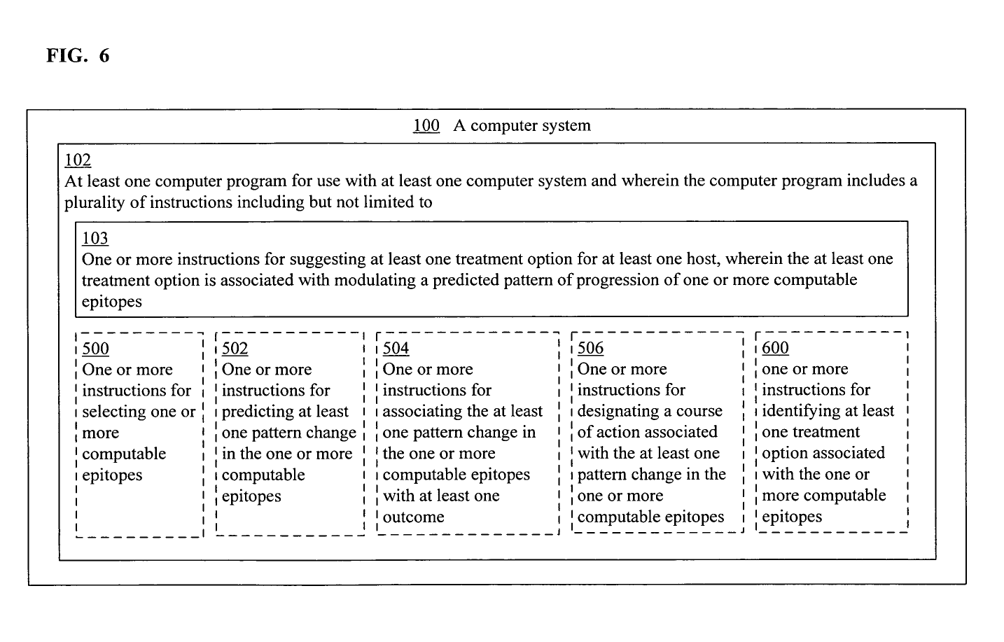

FIG. 6 depicts some exemplary aspects of a system such as that described in FIGS. 1 and 2. A computer system 100 may include at least one computer program for use with at least one computer system 102, where the at least one computer program includes a plurality of instructions. The at least one computer program 102 may include one or more instructions for suggesting at least one treatment option for at least one host, wherein the at least one treatment option is associated with modulating a predicted pattern of progression of one or more computable epitopes 103. The at least one computer program 102 may include one or more instructions for identifying at least one treatment option associated with the one or more computable epitopes 600.

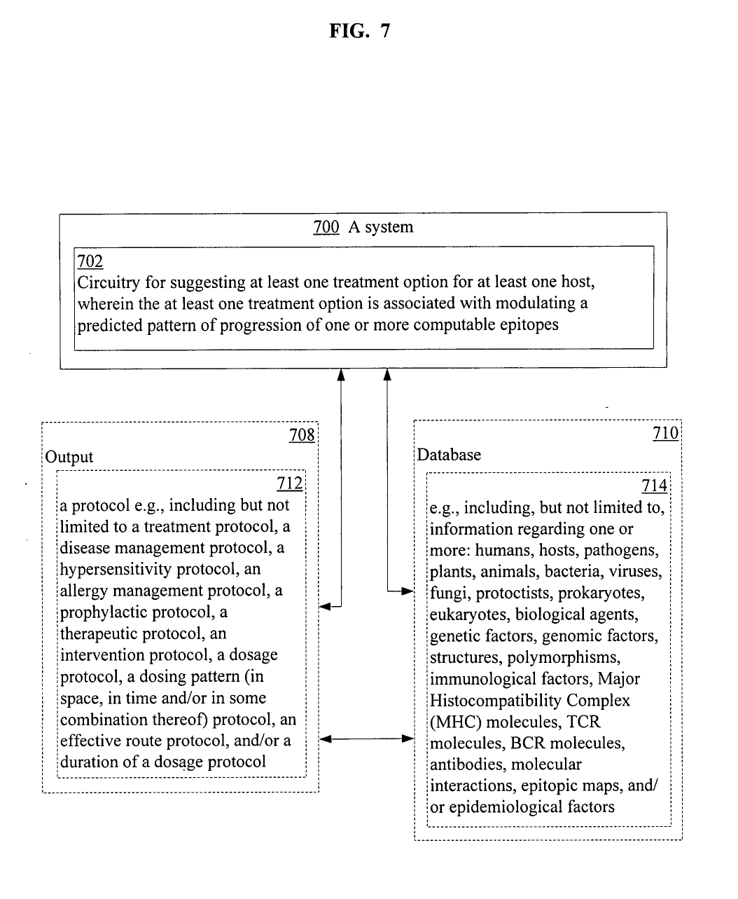

With reference to the figures, and with reference now to FIG. 7, depicted is a partial view of a system that may serve as an illustrative environment of and/or for subject matter technologies. The system 700 may include components and/or circuitry for suggesting at least one treatment option for at least one host, wherein the at least one treatment option is associated with modulating a predicted pattern of progression of one or more computable epitopes 702.

Those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure.

Continuing to refer to FIG. 7, the system 700 may be coupled to at least one database 710 including information designated of at least one type 714, for example, including, but not limited to, information regarding one or more: humans, hosts, pathogens, plants, animals, bacteria, viruses, fungi, protoctists, prokaryotes, eukaryotes, biological agents, genetic factors, genomic factors, structures, polymorphisms, immunological factors, Major Histocompatibility Complex (MHC) molecules, TCR molecules, BCR molecules, antibodies, molecular interactions, epitopic maps, and/or epidemiological factors. One or more outputs 708 may be displayed, for example, in the form of a protocol designated of at least one type 712, for example, including but not limited to a treatment protocol, a disease management protocol, a hypersensitivity protocol, an allergy management protocol, a prophylactic protocol, a therapeutic protocol, an intervention protocol, a dosage protocol, a dosing pattern (in space, in time and/or in some combination thereof) protocol, an effective route protocol, and/or a duration of a dosage protocol. In one aspect the type of output 708 may be selected by the user.

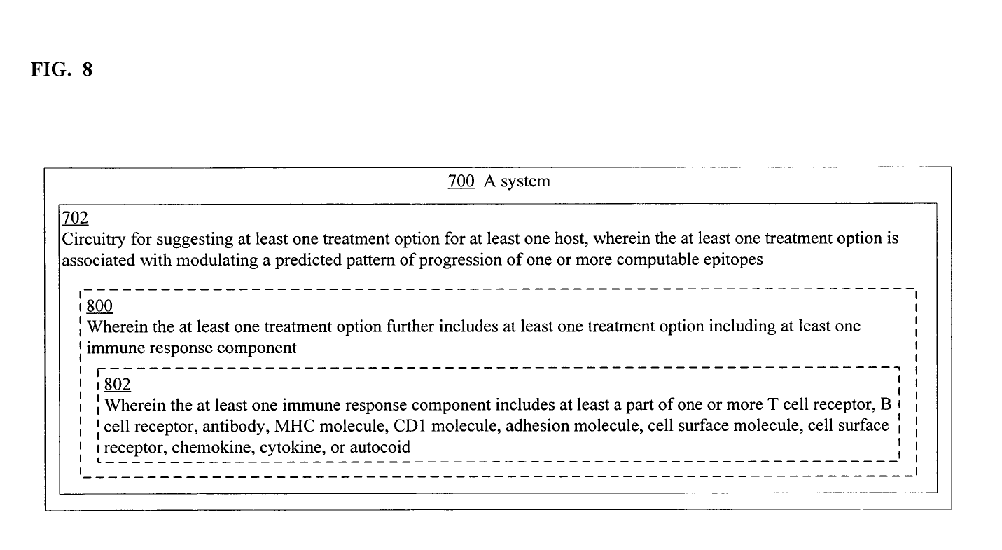

With reference to FIG. 8, depicted is a partial view of a system depicting exemplary aspects of the system depicted in FIG. 7. In one aspect, a system 700 may include components and/or circuitry for suggesting at least one treatment option for at least one host, wherein the at least one treatment option is associated with modulating a predicted pattern of progression of one or more computable epitopes 702. The circuitry for suggesting at least one treatment option for at least one host 702 may include circuitry wherein the at least one treatment option further includes at least one treatment option including at least one immune response component 800. The circuitry 800 may include circuitry wherein the at least one immune response component includes at least a part of one or more T cell receptor, B cell receptor, antibody, MHC molecule, CD1 molecule, adhesion molecule, cell surface molecule, cell surface receptor, chemokine, cytokine, or autocoid 802.

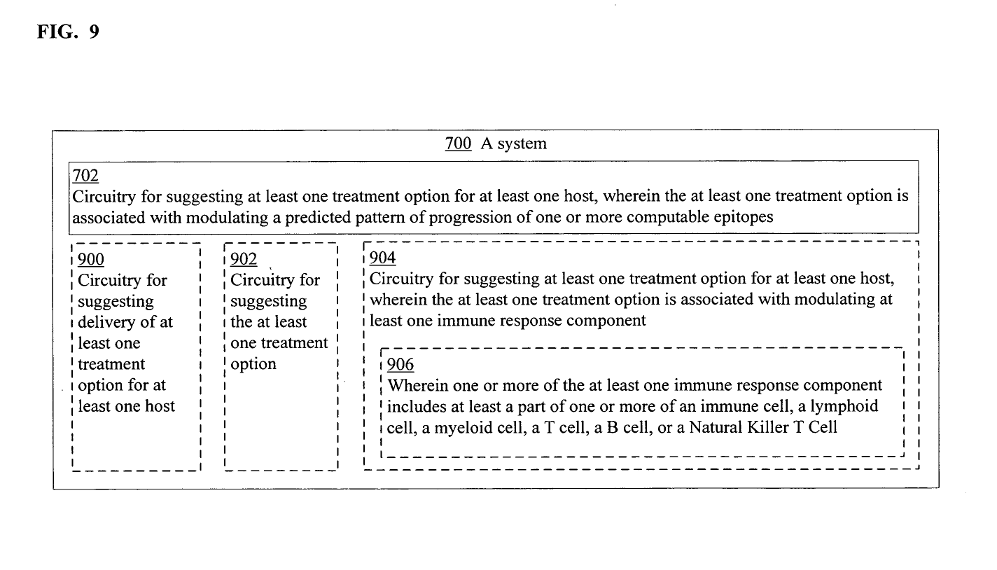

With reference to FIG. 9, depicted is a partial view of a system depicting exemplary aspects of the system depicted in FIG. 7. In one aspect, a system 700 may include components and/or circuitry for suggesting at least one treatment option for at least one host, wherein the at least one treatment option is associated with modulating a predicted pattern of progression of one or more computable epitopes 702. The system 700 may include circuitry for suggesting delivery of at least one treatment option for at least one host 900. The system 700 may include circuitry for suggesting the at least one treatment option 902. The system 700 may include circuitry for suggesting at least one treatment option for at least one host, wherein the at least one treatment option is associated with modulating at least one immune response component 904. The circuitry for suggesting at least one treatment option to at least one host 904 may include circuitry wherein one or more of the at least one immune response component includes at least a part of one or more of an immune cell, a lymphoid cell, a myeloid cell, a T cell, a B cell, or a Natural Killer T Cell 906.

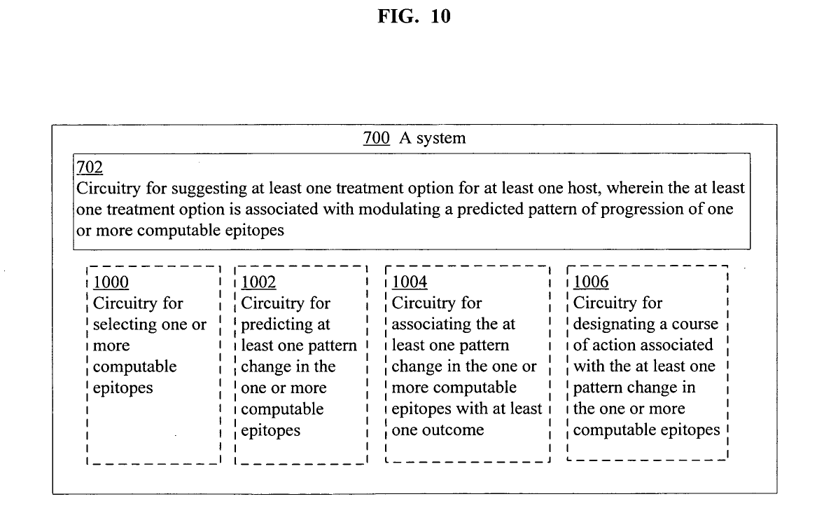

With reference to FIG. 10, depicted is a partial view of a system depicting exemplary aspects of the system depicted in FIG. 7. In one aspect, a system 700 may include components and/or circuitry for suggesting at least one treatment option for at least one host, wherein the at least one treatment option is associated with modulating a predicted pattern of progression of one or more computable epitopes 702. The system 700 may include circuitry for selecting one or more computable epitopes 1000. The system 700 may include circuitry for predicting at least one pattern change in the one or more computable epitopes 1002. The system 700 may include circuitry for associating the at least one pattern change in the one or more computable epitopes with at least one outcome 1004. The system 700 may include circuitry for designating a course of action associated with the at least one pattern change in the one or more computable epitopes 1006.

With reference to FIG. 10, depicted is a partial view of a system depicting exemplary aspects of the system depicted in FIG. 7. In one aspect, a system 700 may include components and/or circuitry for suggesting at least one treatment option for at least one host, wherein the at least one treatment option is associated with modulating a predicted pattern of progression of one or more computable epitopes 702. The system 700 may include circuitry for identifying at least one treatment option associated with the one or more computable epitopes 1100.

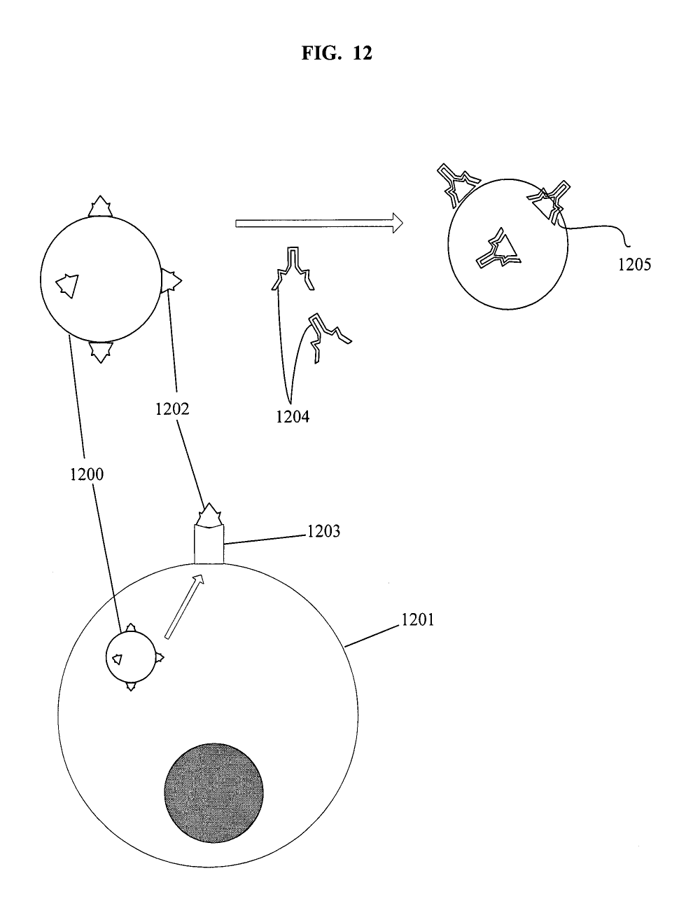

FIG. 12 depicts a diagrammatic view of one aspect of an exemplary interaction of an immune response component, which may be, for example, an antibody 1204 interacting with an epitope 1202 displayed by an agent 1200. In some contexts, an epitope may sometimes be viewed as a type or part of an antigen. As shown in FIG. 12, an epitope 1202 or parts thereof may be displayed by an agent 1200, may be displayed on the surface of an agent 1200, may extend from the surface of an agent 1200, may be internal to an agent, and/or may be only partially accessible by an immune response component. In one aspect, an epitope 1202 may be presented on the surface of a cell 1201 that is itself an agent 1200 or that has incorporated all or part of an agent 1200, as by infection or engulfment. In one aspect a cell 1201 may be an antigen processing cell (APC). In one aspect, an epitope 1202 may include all or part of an antigen synthesized in a cell 1201, as in a host cell, under the direction of all or part of an agent 1200 and may be presented on the surface of or internal to a host cell. In one aspect, an epitope 1202 may include all or part of an antigen synthesized in a cell 1201, perhaps under special circumstances, such as after mutation, cancer, and/or genetic manipulation. An epitope 1202 may be complexed with a presenting molecule 1203 on the surface of a cell 1201, for instance as a result of intracellular processing of an antigen arising from an endogenous or exogenous source.

In one aspect, an epitope 1202 may be linear determinant, including a type which arises from a linear form. For example, portions of its sequence may originate as adjacent to each other, as in a linear protein or non-branching carbohydrate or lipid chain. In another aspect, an epitope 1202 may be of a type that arises from a nonlinear form, for example a conformational antigen such as a protein with amino acids that are non-adjacent in the protein sequence but become adjacent upon protein folding. An epitope might also or instead be modified as by, for example but not limited to, glycosylation, acylation, alkylation, lipoylation, prenylation, myristoylation, palmitoylation, methylation, hydroxylation, and/or phosphorylation. In other examples, an epitope 1202 arising from a nonlinear form might include a branching carbohydrate chain or a lipid with multiple fatty acyl chains, such as a ceramide or sphingolipid, which may further include a sugar moiety. An epitope 1202 arising from a nonlinear form may result from intracellular processing, including processing other than linear, and/or exo-active degradation.

An epitope 1202 arising from a linear form or from a nonlinear form may be presented on a cell 1201 complexed to a presenting molecule 1203. For example, an epitope may result from intracellular processing of an antigen by cellular machinery including but not limited to a proteasome, which may be an immunoproteasome, and the epitope 1202 be presented on a cell 1201 and complexed to a presenting molecule 1203 that is a MHC Class I molecule. In one example of typical processing of an intracellular agent, an epitope 1202 that is a peptide might arise by processing, in a proteasome and/or elsewhere in a cell 1201, of an antigen such as all or part of an agent 1200, having been incorporated as by infection, or a compound synthesized in the cell 1201 under the direction of the agent 1200. Instead or in addition, an epitope 1202 might include all or part of a self-antigen that is part of a cell 1201, such as an intracellular and/or nuclear component, and which may be, for instance, indicative of a disease state of the cell such as but not limited to normalcy, anaplasia, malignancy, and/or infection. An epitope 1202 may arise by intracellular processing that includes nonlinear degradation and/or degradation of noncontiguous sequences. Such processing might also or instead include splicing of an epitope from two or more noncontiguous sections as in excision of a portion of an antigen with ligation of the two ends, in either the original sequential order or with one or more section altered, as in reverse order. More information may be found in: Warren, et al., An Antigen Produced by Splicing of Noncontiguous Peptides in the Reverse Order, Science 313, 1444 (2006); Hanada et al., Immune recognition of a human renal cancer antigen through post-translational protein splicing, Nature 427:252 (2004), and Vigneron et al., An antigenic peptide produced by peptide splicing in the proteosome, Science 304:587 (2004), which are incorporated herein by reference. Degradation might be initiated by exo-active or internal cleavage and proceed in a uni-directional or bidirectional fashion. Processing that includes internal cleavage and/or bidirectional activity, for instance, might enable degradation of a protein that is conformationally unavailable for linear processing. See e.g. Piwko, W. and Jentsch, S., Proteasome-mediated protein processing by bidirectional degradation initiated from an internal site, Nature Structural and Mol. Biol. 13(8) 691-697 (2006), which is incorporated herein by reference. An epitope 1202 might also or instead be the product of or affected by other enzymatic action, with or without proteasomal processing, including processing by one or more peptidase outside the proteasome, such as an Endoplasmic Reticulum Aminopeptidase or a cytosolic aminopeptidase. See e.g.: York et al., Endoplasmic reticulum aminopeptidase 1 (ERAP1) trims MHC class I-presented peptides in vivo and plays an important role in immunodominance, PNAS 103; 9202-9207 (2006); Saveanu, et al., Complexity, contradictions, and conundrums: studying postproteasomal proteolysis in HLA class I antigen presentation Immunological Reviews Vol. 207: 42-59 (2005); Guil et al., Need for Tripeptidyl-peptidase II in Major Histocompatibility Complex Class I Viral Antigen Processing when Proteasomes are Detrimental, J. Biol. Chem. 281(52): 39925-39934, (2006); York et al., Tripeptidyl peptidase II is the major peptidase needed to trim long antigenic precursors, but is not required for most MHC class I antigen presentation, J. Immunol. 177(3), 1434-1434 (2006); Reits et al., A Major Role for TPPII in Trimming Proteasomal Degradation Products for MHC Class I Antigen Presentation Immunity, 20, 495-506, (2004), Craiu, et al. Two distinct proteolytic processes in the generation of a major histocompatibility complex class I-presented peptide, PNAS 94: 10850-10855 (1997), Rock et al., Post-proteasomal Antigen Processing for Major Histocompatibility Complex Class I presentation. Nature Immunology 7, 670-677 (2004); and Wherry et al., Re-evaluating the Generation of a “Proteasome-Independent” MHC Class I-Restricted CD8 T Cell Epitope The Journal of Immunology, 176: 2249-2261 (2006), which are all incorporated herein by reference. An epitope 1202 presented on a cell surface, including, for instance, one presented by an MHC Class I molecule, may further be the result of interaction with one or more transporter including, for example, a Transporter Associated with Antigen Processing (TAP), or an SEC61 transport complex.

In one aspect, an epitope 1202 may be a product of an immunoproteasome, for instance in a cell 1201 that has been activated, as by a cytokine. Such an epitope, for example, may be a portion of an agent 1200, perhaps one that is a pathogen such as a virus. In another example an epitope 1202 is a self-epitope, for instance one that arises as a consequence of processing of a cellular protein by an immunoproteasome with or without extra-proteasomal processing. Such an epitope may be involved in the induction of an autoimmune response.

An epitope 1202 may be the result of processing all or part of an agent 1200 in an endosome-lysosome compartment of a cell 1201 and be presented on the surface of the cell 1201 by a presenting molecule 1203 that is, for instance, a MHC Class II molecule. In one example of typical processing of an extracellular agent, an agent 1200, such as an extracellular bacteria, is engulfed by a cell 1201, such as an APC, and the resulting endosome fuses with a lysosome containing enzymes that degrade the agent and, subsequently, with vesicles containing MHC Class II molecules. After fusion with the cell membrane, the epitope/MHC Class II complex may be presented on the surface of the cell 1201. An epitope 1202 may also or instead result from nontypical processing involving a lysosome within a cell 1201. In an example of such nontypical processing, an endosome is formed by autophagy in which a membrane surrounds all or part of an intracellular agent, such as a virus or component thereof, or other pathogen such as an intracellular pathogen like Mycobacterium tuberculosis, or an intracellular component. A compartment thus formed can fuse to a lysosome, with subsequent formation and presentation on the cell surface of an epitope/MHC complex. Instead or in addition, chaperone molecules such as LAMP2a and/or Hsc 70 may function in transporting intracellular-residing compounds directly into a lysosome with subsequent processing. An intracellular epitope processed by such a nontypical pathway may be presented by a presenting molecule not typically associated with such an epitope, for instance an MHC Class II molecule, and/or be available to an immune response component that it might otherwise not access, possibly resulting in responses such as autoimmunity, anti-tumor responses, and/or destruction of one or more intracellular pathogen. More information can be found in: Schmid and Münz, Immune surveillance of intracellular pathogens via autophagy, Cell Death and Differentiation 12, 1519-1527; (2005); Münz, Autophagy and antigen presentation, Cellular Microbiology 8(6), 891-898 (2006); and Lee et al., Autophagy-Dependent Viral Recognition by Plasmacytoid Dendritic Cells, Science 315, 1398-1401 (2007), and references therein, which are hereby all incorporated by reference.

An epitope 1202, such as one arising from an agent 1200 that is a microbe, for instance a mycobacterium, may be or include a lipid moiety and/or one or more saccharide. An epitope 1202 may be presented on the surface of a cell 1201 on a presenting molecule 1203 that is a Cluster of Differentiation (CD) 1 molecule, for instance CD1a, CD1b, CD1c, or CD1d, after having been processed. For example, an epitope 1202 may arise from a pathogen, such as Mycobacterium tuberculosis, that has been incorporated by a cell 1201, such as a dendritic cell. The epitope may be processed in an endosome and/or the endoplasmic reticulum and loaded onto a CD1 molecule, produced de novo or recycled from the membrane, as through the actions of one or more enzyme involved in degradation and trafficking, and/or one or more lipid-transfer protein such as a sphingolipid activator protein, for example a saposin, or microsomal triglyceride transfer protein. An epitope 1202 may be presented on a CD1 molecule after loading at the surface of a cell 1201. More information can be found in: De Libero and Mori, Recognition of Lipid Antigens by T Cells, Nature Reviews Immunology 5(6), 485-496 (2005); De Libero, How T lymphocytes recognize lipid antigens, FEBS Lett. 580(23), 5580-5587 (2006); and Yuan et al., Saposin B is the dominant saposin that facilitates lipid binding to human CD1d molecules, PNAS 104, 5551-5556 (2007), which are incorporated herein by reference.

An epitope 1202 might be presented by a presenting molecule 1203 that is not typically associated with such an epitope but that has accessed and complexed with the epitope 1202, as during autophagy and/or cross-presentation. For example, an epitope 1202 might include all or part of an exogenous antigen that is typically processed in an endosome-lysosome compartment and presented on an MHC Class II molecule, but which has instead been processed by intracellular machinery and presented on an MHC Class I molecule of a cell, such as an APC. Many possible avenues for cross-presentation are known in the art, as discussed in Groothius and Neefjes, The many roads to cross-presentation, JEM 202(10), 1313-1318, (2005) which is incorporated herein by reference. In one example of such nontypical processing, an epitope being processed in an endosome-lysosome compartment might fuse with a vesicle containing an MHC Class I molecule that has been recycled endocytically, or an epitope may be endocytosed, perhaps after binding to a cell surface receptor and/or cross an organelle membrane to the cytosol where it is processed, for example by a proteasome. See e.g. Burgdorf et al., Distinct Pathways of Antigen Uptake and Intracellular Routing in CD4 and CD8 T Cell Activation, Science, 316, 612-616 (2007), which is incorporated herein by reference. Such processing may include actions by, for instance, a transporter such as but not limited to TAP, and/or one or more cellular component associated with the endoplasmic reticulum. In another example, an epitope might be transferred from an infected cell to, for example, a dendritic cell, through a connection between the cells such as a protein channel or gap junction. See e.g. Neijssen et al., Cross-presentation by intercellular peptide transfer through gap junctions, Nature 434, 83-85, (2005) which is incorporated herein by reference. Or, an epitope 1202 and/or an agent 1200 might be an apoptotic body, exosome, or other liberated element that has been incorporated and processed by a cell, such as an APC, and the epitope presented on the cell surface by the cell's MHC or CD1 molecule. Or a similar exogenous element may fuse with a cell membrane to present its foreign MHC/epitope complex. See, for example, Dolan et al., Dendritic Cells Cross-Dressed with Peptide MHC Class I Complexes Prime CD8+ T Cells, The Journal of Immunology, 177, 6018-6024, (2006) which is incorporated herein by reference. Instead or in addition an epitope may be internalized by, for instance, a dendritic cell via an Fc receptor and antibody-mediated antigen uptake, as during an innate response, and then be presented by an MHC Class I and/or Class II molecule, as is discussed in Harbers et al., Antibody-enhanced cross-presentation of self antigen breaks T cell tolerance, J. Clin. Invest., 117(5), 1361-1369 (2007) which is incorporated herein by reference. Cross-presentation may enable presentation, as by an APC, of an epitope otherwise inaccessible to a type of presenting molecule and associated immune responses, and thereby enable one or more type of immune response, as by, for instance, cross-priming. In one example, an exogenous antigen normally presented on an MHC Class II molecule to a CD4+ T cell might instead undergo processing and cross-presentation and be presented on an MHC Class I molecule to a CD8+ molecule, promoting its activation. In one example a microbial lipid present in an apoptotic body arising from a cell with no CD1 molecule could be engulfed and presented by a dendritic cell on its CD1 and thereby presented to a T cell. Cross-presentation of an epitope 1202 may be involved in immunogenic responses relevant, for example, to vaccination. Cross-presentation of an epitope 1202 may be involved in presentation of and/or response to one or more epitopes that include or resemble a part or all of a self-antigen, and/or may be relevant to, for example, autoimmunity, infection, and/or tumor suppression. Loss of cross-presentation, for example by tumor cells and/or through viral intervention, can result in an altered immune response. See for example, Harbers et al., Antibody-enhanced cross-presentation of self antigen breaks T cell tolerance, J. Clin. Invest.; 117(5): 1361-1369 (2007) and Neijssen et al., Cross-presentation by intercellular peptide transfer through gap junctions, Nature (434) 83-85, (2005) which are incorporated herein by reference.

Continuing to refer to FIG. 12, in one aspect, an immune system may launch a response, for example, one resulting in a humoral immune response producing antibodies 1204 capable of recognizing and/or binding to an epitope 1202, followed by the subsequent lysis or degradation of the agent 1200. Mechanisms by which an antigen, such as an epitope 1202, elicits an immune response are known in the art. In one aspect, the binding of an antibody 1204 to an epitope 1202 may form an antigen-antibody complex 1205 that may be characterized as a lock-and-key fit. In another aspect, the binding affinity of an antibody for an epitope may vary in time (e.g., in the course of ‘affinity maturation’) and/or with physiological circumstances. In yet another aspect, an antigen and antibody may bind with varying degrees of reversibility. The binding or the dissociation of an antigen-antibody complex may be manipulated, for example, by introducing a small (possibly solvated) atom, ion, molecule or compound that promotes association or disassociation.

In one aspect, a computable epitope is predicted to have a corresponding physical structure of an epitope 1202 that may be capable of evoking an immune response. The strength and/or type of such an immune response may vary. For example, an epitope 1202 may evoke a weak response and/or a medium response. In one aspect, the immune system is an adaptive system capable of employing several parallel and/or complementary mechanisms, for example, as a defense against a pathogen. An epitope 1202 may elicit a cell mediated immune response and/or a humoral immune response. It is contemplated that in one instance an epitope 1202 selected for targeting may be one that is predicted to evoke a weak response in the host; however, it may be predicted to be selective to the agent 1200. In another example, a selected epitope 1202 may be predicted to evoke a weak response in the host; however, it may be selected for targeting, as when it is common to a number of agents deemed to be targets. The herein described implementations are merely exemplary and should be considered illustrative of like and/or more general implementations within the ambit of those having ordinary skill in the art in light of the teachings herein.

The term “immune response component,” as used herein, may include, but is not limited to, at least a part of a hematopoietic cell, a stem cell, a progenitor cell, a myeloid cell, a monocyte, a macrophage, a neutrophil, a dendritic cell, an antigen presenting cell, a phagocyte, a basophil, a cytotoxic cell, a lymphocyte, a T-lymphocyte, a killer T-lymphocyte, a suppressor T-cell, regulator T cell, a CD4+ T cell, a CD8+ T cell, a helper T-cell, an antigen receptor, a cytotoxic T-cell, a Natural Killer T cell, a natural killer cell, a T-8 lymphocyte, a T cell receptor, a T cell receptor complex, a genetically engineered cell, a B lymphocyte, a B cell receptor, an antibody, a recombinant antibody, a genetically engineered antibody, a chimeric antibody, a monospecific antibody, a bispecific antibody, a multispecific antibody, a diabody, a humanized antibody, a human antibody, a heteroantibody, a monoclonal antibody, a polyclonal antibody, a camelized antibody, a deimmunized antibody, an anti-idiotypic antibody, an antibody fragment, a synthetic antibody, an immune synapse, an MHC molecule, a Cluster of Differentiation (CD) molecule, a CD1 molecule, an immune response modulator, an autocoid, a cytokine, a lymphokine, and/or an adhesion molecule. The term “immune response component,” as used herein, may include one or more part of any component of an immune system that may bind to an antigen and/or an epitope thereof in a specific and/or a useful manner, and/or any single, combined, or complexed component or modulator of an immune system able to effect and/or affect an immune response to an exogenous or endogenous antigen or epitope. The term “immune response component,” as used herein, may include a naturally occurring, recombinant, or synthetic compound.

The term “immune response” may include, but is not limited to a humoral response, a cell mediated immune response, an autoimmune response, a hyperimmune response, an inflammatory response, an innate response, an immune tolerance, and/or a hypersensitivity response.

The term “antibody,” as used herein, may include but is not limited to: an antibody, a recombinant antibody, a genetically engineered antibody, a synthetic antibody, a chimeric antibody, a monospecific antibody, a bispecific antibody, a multispecific antibody, a TCR-like antibody, a diabody, a humanized antibody, a human antibody, a heteroantibody, a monoclonal antibody, a polyclonal antibody, a camelized antibody, a deimmunized antibody, an anti-idiotypic antibody, a synthetic antibody, and/or an antibody fragment. The term “antibody” may include but is not limited to types of antibodies such as IgA, IgD, IgE, IgG and/or IgM, and/or the subtypes IgG1, IgG2, IgG3, IgG4, IgA1 and/or IgA2. The term “antibody” may include, but is not limited to, an antibody fragment such as at least a portion of an intact antibody, for instance, the antigen binding variable region. Examples of antibody fragments include Fv, Fab, Fab′, F(ab′), F(ab′).sub.2, Fv fragment, diabody, linear antibody, single-chain antibody molecule, multispecific antibody, and/or other antigen binding sequences of an antibody. Additional information may be found, for example, in: U.S. Pat. No. 5,641,870 to Rinderknecht et al., entitled “Low hydrophobic interaction chromatography for antibody purification”; U.S. Pat. No. 4,816,567 to Cabilly et al., entitled “Recombinant immunoglobin preparations”; Publication WO 93/11161 for Whitlow et al., entitled “Multivalent antigen-binding proteins”; Holliger et al., Diabodies: small bivalent and bispecific antibody fragments, PNAS, 90: 6444-6448 (1993); and Zapata et al., Engineering linear F(ab′)2 fragments for efficient production in Escherichia coli and enhanced antiproliferative activity, Protein Eng. 8(10): 1057-1062 (1995), which are all incorporated herein by reference. Antibodies may be generated, as for therapeutic purposes, by a variety of known techniques, such as, for example, phage display, and/or transgenic animals and/or organisms.

The term “antibody,” as used herein, may include an anti-idiotypic antibody. In some aspects, an anti-idiotypic antibody may elicit a desirable immune response. For example, an anti-idiotypic antibody may be capable of evoking an immune response equal to or greater than a response elicited by the same binding site. Anti-idiotypic antibodies may be rapidly selected, for example, by phage display technology. Additional information may be found in U.S. Patent Application No. 20040143101, to Soltis et al., entitled “Immunoglobulin construct containing anti-mucin variable domain sequences for eliciting an anti-idiotype anti-tumor response,” which is incorporated herein by reference.

The term “heteroantibody,” as used herein, may include but is not limited to two or more antibodies, antibody fragments, antibody derivatives, and/or antibodies with at least one specificity, that are linked together. Additional information may be found in U.S. Pat. No. 6,071,517, to Fanger et al., entitled “Bispecific heteroantibodies with dual effector functions,” which is incorporated herein by reference.

The term “chimeric antibody,” as used herein, may include, but is not limited to, antibodies having mouse-variable regions joined to human-constant regions. In one aspect, “chimeric antibody” includes antibodies with human framework regions combined with complementarity-determining regions (CDRs) obtained from an animal such as a mouse and/or rat; those skilled in the art will appreciate that CDRs may be obtained from other sources. Additional information may be found in EPO Publication No 0239400 to Winter, G P, entitled “Recombinant antibodies and methods for their production” which is incorporated herein by reference.

The term “humanized antibody,” as used herein, may include, but is not limited to, an antibody having one or more human-derived regions, and/or a chimeric antibody with one or more human-derived regions, also considered the recipient antibody, combined with CDRs from a donor mouse and/or rat immunoglobulin. In one aspect, a humanized antibody may include residues not found in either donor and/or recipient sequences. A humanized antibody may have single and/or multiple specificities. Additional information may be found in U.S. Pat. No. 5,530,101, to Queen et al., entitled “Humanized immunoglobulins” and U.S. Pat. No. 4,816,567, to Cabilly et al., entitled “Recombinant immunoglobin preparations” which are incorporated herein by reference. Information may also be found in: Jones et al., Replacing the complementarity-determining regions in a human antibody with those from a mouse, Nature, 321:522-525(1986); Riechmann et al., Reshaping human antibodies for therapy, Nature, 332:323-327 (1988); and Verhoeyen et al., Reshaping human antibodies: grafting an antilysozyme activity, Science, 239:1534-1536 (1988), which are all incorporated herein by reference.

The term “human antibody,” as used herein, may include, but is not limited to, an antibody with variable and constant regions derived from human immunoglobulin sequences. The term “human antibody” may include but is not limited to amino acid residues of non-human origin, such as those introduced into an antibody. Human antibodies may encoded by nucleic acid sequences containing changes from one or more canonical sequences, such as, for example, residues introduced by site-directed mutations, random mutations, and/or insertions. Methods for producing human antibodies are known in the art. Additional information may be found in U.S. Pat. No. 4,634,666, to Engleman et al., entitled “Human-murine hybridoma fusion partner,” which is incorporated herein by reference.

The term “recombinant antibody,” as used herein, may include an antibody formed and/or created by recombinant technology, including, but not limited to, chimeric, human, humanized, hetero-antibodies and/or the like.

The term “synthetic antibody” as used herein, may include all or part of an antibody that is manufactured, as by chemical, biochemical, and/or enzymatic means.

The term “TCR-like antibody,” as used herein, may include an antibody or parts thereof that is specific for an epitope-MHC complex. Additional information may be found in Denkberg et. al., Direct visualization of distinct T cell epitopes derived from a melanoma tumor-associated antigen by using human recombinant antibodies with MHC restricted T cell receptor-like specificity, PNAS 99 (14) 9421-9426 (2002), which is incorporated herein by reference.

The term “B cell receptor,” as used herein, may include but is not limited to a receptor that includes a membrane immunoglobulin chain (mlg) anchored to the surface of a B cell with or without other components forming a B cell receptor complex. Additional information may be found in Roitt's Essential Immunology, (11th edn) by Ivan M. Roitt, Seamus J. Martin, Peter J. Delves, Dennis Burton, Blackwell Publishing.

The term “T cell receptor,” as used herein, may include but is not limited to an oligomer of integral membrane proteins, sometimes referred to in the art as α, β, γ, and δ chains, with or without an associated CD3 or similar complex (see for example Enyedy et al., Fce Receptor Type I g Chain Replaces the Deficient T Cell Receptor ζ Chain in T Cells of Patients With Systemic Lupus Erythematosus Arthritis and Rheumatism 44:1114-1121 (2001), which is incorporated herein by reference), that is on the surface of a T cell, and/or a soluble T cell receptor, an artificial T cell receptor, a TCR-like antibody expressed on a T lymphocyte, a synthetic T cell receptor, a genetically engineered T cell receptor, and/or any component or combination thereof. A “T cell receptor” may include or be part of an immune synapse. The terms “TCR complex” and “immune synapse” as well as components thereof are well known to those skilled in the art. More information may be found in the review by Richman et al., Display, engineering, and applications of antigen-specific T cell receptors Biomolecular Engineering (2007), which is incorporated herein by reference. Methods for generating T cell receptors are described in US patent applications, including: US Application number 20070082362 to Jakobsen et al., entitled “Modified soluble T cell receptor”; U.S. Application No. 2006/0166875 to Jakobsen et al., entitled “Single chain recombinant T cell receptors”; US Application No. 2006/0135418 to Jakobsen et al., entitled “Receptors”; and US Application No. 2005/0009025 to Jakobsen et al., entitled “Substances,” all of which are incorporated herein by reference.

The terms “artificial T cell receptor” or “chimeric T cell receptor,” as used herein, may include but are not limited to a T cell receptor consisting of combinations of α, β, γ, and δ chains, variable and constant regions, and/or a T-cell receptor generated by joining an epitope-recognizing domain (ectodomain) to the transmembrane and intracellular portion of a signaling molecule (endodomain). The ectodomain may be composed of parts of antibodies or T cell receptors or other molecules. The ectodomain may also be a TCR-like antibody. Methods for generating artificial and/or chimeric T-cell receptors are described in: Pule et. al., Artificial T cell receptors, Cytotherapy, 5 (2), 211-226 (2003); Willemsen et. al., Genetic engineering of T cell specificity for immunotherapy of cancer, Hum Immunol. 64(1), 56-68 (2003); Willemsen et. al., Grafting primary human T lymphocytes with cancer specific chimeric single chain and two chain TCR Gene Therapy 7, 1369-1377, (2000); and Willemsen et. al., T Cell Retargeting with MHC Class I-Restricted Antibodies: The CD28 Costimulatory Domain Enhances Antigen-Specific Cytotoxicity and Cytokine Production Journal of Immunology 174: 7853-7858, (2005), which are all incorporated herein by reference.

The term “genetically engineered T cell,” as used herein, may include but is not limited to, for example, an autologous, allogenic, heterologous, and/or xenogenic T cell genetically modified to one or more express agent- or epitope-specific immune receptor, including for example an artificial or chimeric T cell receptor. Methods for generating genetically engineered T cells are described in: Willemsen et. al., Genetic engineering of T cell specificity for immunotherapy of cancer, Hum Immunol., 64(1), 56-68 (2003); and Pule et. al., Artificial T cell receptors, Cytotherapy, 5 (2), 211-226 (2003), which are incorporated herein by reference.

The term “MHC molecule,” as used herein, may include but is not limited to a heterodimeric peptide-binding protein on the surface of a cell or in solution, with or without epitopes bound to the appropriate grooves, a soluble Zn-α₂-glycoprotein (ZAG) and/or any component thereof. Methods for generating various forms of MHC molecules are known. Additional information may be found in: Lev et. al., Tumor-specific Ab-mediated targeting of MHC-peptide complexes induces regression of human tumor xenografts in vivo, PNAS, 101, 9051-9056 (2004); and Oved et al., Antibody-mediated targeting of human single-chain class I MHC with covalently linked peptides induces efficient killing of tumor cells by tumor or viral-specific cytotoxic T lymphocytes, Cancer Immunol Immunother (2005) 54: 867-879, which are incorporated herein by reference.

The term “agent,” as used herein, may include, for example, but is not limited to, all or part of an organism, a genetically engineered organism, a synthetic organism, a virus, a dependent virus, an associated virus, a defective virus, a synthetic virus, a genetically engineered virus, a bacterium, a yeast, a fungus, a protoctist, an archaea, a phage, a nanobacterium, a prion, an agent responsible for a transmissible spongiform encephalopathy (TSE), a multicellular parasite, a protein, an infectious protein, a polypeptide, a polyribonucleotide, a polydeoxyribonucleotide, a polyglycopeptide, a polysaccharide, a nucleic acid, an infectious nucleic acid, a polymeric nucleic acid, a lipid, a lipid micelle, a lipid bilayer, a lipopolysaccharide, a glycolipid, a metabolic byproduct, a cellular byproduct, and/or a toxin. The term “agent,” as used herein, may include, but is not limited to, a putative causative agent of a disease, disorder, syndrome, or pathology; or a cell or component thereof that is deemed, for example, a target for therapy and/or a target for neutralization; and/or a cell whose apoptosis, phagocytic engulfment, removal, lysis or functional degradation may prove beneficial to the host. The term “agent” may also include, but is not limited to, a byproduct or output of a cell that may be neutralized and/or whose removal or functional neutralization may prove beneficial to the host. The term “agent” may include an agent belonging to the same family or group as the agent of primary interest, or an agent exhibiting a common and/or a biological function relative to the agent of primary interest.

The term “epitope,” as used herein, may include, but is not limited to, a sequence of at least 3 amino acids, a sequence of at least nine nucleotides, an amino acid, a nucleotide, a carbohydrate, a protein, a lipid, a capsid protein, a coat protein, a peptide, a glycoprotein, a carbohydrate, a polysaccharide, an oligosaccharide, a saccharide, a lipopolysaccharide, a glycolipid, a glycoprotein, a lipid, a fatty acid, a phospholipid, a glycolipid, a sphingolipid, a glycerolipid, a lipoprotein, and/or at least a part of a cell, an organism, or a virus. As used herein, the term “epitope” may, if appropriate to context, be used interchangeably with antigen, paratope binding site, antigenic determinant, and/or determinant. As used herein, the term “determinant” can include an influencing element, determining element, and/or factor, unless context indicates otherwise. In one aspect, the term “epitope” includes, but is not limited to, a binding site on a peptide. As used herein, the term “epitope” may include sequences structurally and/or functionally similar to an epitope found in an agent or host. The term “epitope” includes, but is not limited to, similar sequences observed between orthologs, paralogs, homologs, isofunctional homologs, heterofunctional homologs, heterospecific homologs, and/or pseudogenes or products thereof, of an agent. An epitope may be or include a portion of an agent. In one aspect, an epitope may include at least a portion of a gene or gene-expression product. In another aspect, an epitope may include at least a part of a non-coding region of nucleic acid.

The term “computable epitope” as used herein, includes, but is not limited to, an epitope whose current form and likely future forms may be predicted by using, for example, including, but not limited to, computer-based predictive methodology and/or evolutionary methods, and/or cellular processing models and/or probabilistic evolutionary models and/or probabilistic defect models and/or probabilistic mutation models and/or probabilistic processing models. For example, Smith, et al. in their article regarding the history of the antigenic evolution of the human influenza virus, entitled “Mapping the Antigenic and Genetic Evolution of Influenza Virus,” Science 305, 371-376 (2004), which is incorporated herein by reference, present in the paper's Table 1 and the supporting text thereof a set of patterns of viral coat-protein epitopic evolution which constitutes a basis for predicting one or more patterns of epitopic evolution in this particular agent, which may constitute a threat to human populations. In one aspect, a computable epitope may be suggested by, for example, including, but not limited to, predictive parallel extrapolations with similar structure, key residues, and/or the presence of known domains. In another aspect, mathematics, statistical analysis and/or biological structural and/or cellular protein processing modeling tools may provide relevant information for designating or identifying a computable epitope. One specific example of a computable epitope is a polypeptide associated with the HIV-1 virus, which may be, for example, seven to ten amino acids long. Knowing any starting state of such a polypeptide (e.g., how the various amino acids are sequenced/arranged), and using current computational techniques, it is practicable to calculate the likely future combinations of the seven to ten amino acids in the peptide so as to be able to predict how the epitope will likely appear as evolution/change occurs in the epitope as biological processes progress. Indeed, many such evolutionary progressions in the protein sequences of the viral proteins (e.g., reverse transcriptase and protease) of the several major strains of HIV-1 virus have been reported in the literature, and are used in considering the clinical progression of disease in patients. Consequently, in some implementations, technologies described herein computationally predict how the epitope(s) will appear in future mutable forms. This predictive knowledge allows for the designation of at least one immune response component operable for modulating (e.g., reducing and/or eliminating) at least one “future version” of some posited presently existing epitope. As an example, one might predict the five or six most likely ways in which at least one epitope of a viral protein of a current strain of HIV-1 might appear a few months in the future, and then designate that a person's immune cells be exposed to the chemical structures of the epitopes of such future HIV-1 strains to produce an immune response ready, waiting, and keyed to such future epitopic variants of the at least one HIV-1 strain. Once such antibodies or other immune response components have been designated, amplification or adjuvant techniques may be suggested to produce usefully-large quantities of such antibodies or other immune responses or modifiers thereof at a time earlier than the elapsing of the three months, and such antibodies or other immune response components or modifiers thereof, such as a vaccine, be designated to a host, such as a specific host or population. Then, if the HIV-1 virus does evolve or mutate in at least one of the five or six computationally predicted ways, information will be available regarding antibodies or other specific immune response components able to negate the HIV-1 virus as it mutates along the predicted paths and thereby effectively preclude its mutational escape. Examples listed herein are merely illustrative of methodology that may be used for designating the computable epitope and are not intended to be in any way limiting.

The term “cell mediated immune response,” as used herein, may include, but is not limited to, a response involving, utilizing, and/or promoting T cell maturation, proliferation and/or differentiation, and/or the modulation of a macrophage, a natural killer cell, a T cell, a helper T cell, a memory T cell, a suppressor T cell, a regulator T cell, and/or a cytotoxic T cell, and/or the production, release, and/or effect of one or more cytokine or autocoid. The term “cell mediated immune response,” as used herein, may include a response involving a genetically engineered, synthesized, or artificial T cell.

The term “disease state” as used herein, may include, but is not limited to a condition of an organism or its tissue at a given time, including a condition atypical for such an organism or tissue. Such a state might include a pathogenic state like infection, by for instance an agent such as one or more virus, bacterium, parasite, or infectious protein. Or, such a state might be a responsive state, including but not limited to an appropriate immune response, hyperimmune response, hypersensitive response, allergic response, inflammatory response, or an autoimmune response. As used herein, the term “disease state” may include clinically diagnosed disease as well as disruptions in the normal metabolic state of an organism that have not been diagnosed as clinical disease. The term “disease state” may also refer to a state with no apparent presence of a disease and/or no apparent alteration in the condition of, or apparent deviation from the norm of, the organism. The term “disease state” may be used interchangeably and/or incorporate the words disorder, syndrome, symptom, injury, or dysfunction.

In one aspect, one or more agent may be a subtype of the agent 1200. In this aspect, a set of epitopes may be selected for targeting the agent 1200. In another aspect, one or more agents may be secondary, opportunistic agents capable of aiding or exaggerating an infection formed by a first agent 1200. In yet another aspect, one or more agents may be agents known to establish a foothold in a host organism prior to or subsequent to an infection or in response to a host's attenuated immune response.

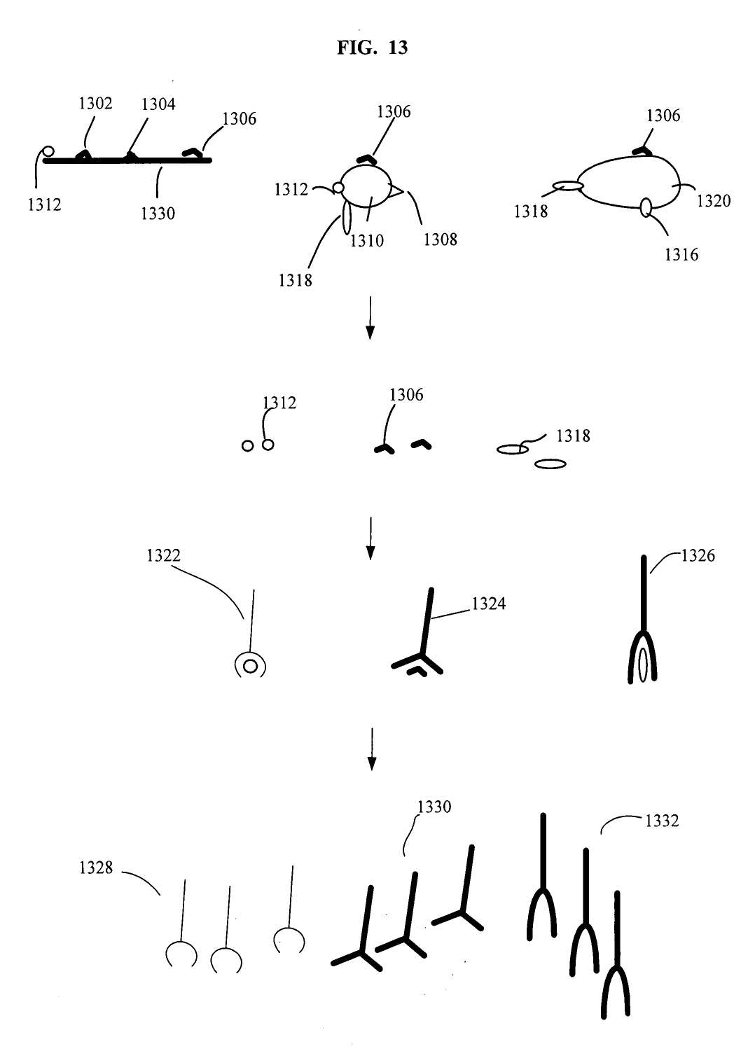

With reference to the figures, and with reference now to FIG. 13, depicted is a diagrammatic view of one aspect of a method of enhancing an immune response. In one aspect, a predicted effective treatment therapy towards a disease and/or a disorder and/or disease state may include one or more immune response components designed to recognize one or more computable epitopes common to one or more agents. Such common or shared computable epitopes may represent an effective target group of epitopes. The immune response components designed to seek out and neutralize the common computable epitopes may be predicted to be effective against one or more agents.

With reference now to FIGS. 12 and 13, in one aspect, a shared epitope 1306 is depicted as common to three agents 1330, 1310 and 1320. In another aspect, a second shared epitope 1312 is common to two agents 1330 and 1310. In yet another aspect, a third shared epitope 1318 is common to two agents 1310 and 1320. However, not all computable epitopes are shared epitopes. For example, as shown in FIG. 13, epitopes 1302 and 1304 are present only on agent 1330 and not on agents 1310 and 1320, while epitope 1308 is unique to agent 1310 and epitope 1316 is unique to agent 1320. Identifying a subset of common computable epitopes shared amongst two or more agents, including between two or more portions of two or more agents, may be done by statistical analysis, for example, by metaprofiling.

Continuing to refer to FIGS. 12 and 13, in one aspect, two or more agents such as 1330, 1310, and 1320 depicted may share a subset of common computable epitopes. A selection of computable epitopes may depend on a number of criteria. For example, an initial selection may be based on selection criteria including, but not limited to, the predicted number of instances of presentation of an epitope 1202 by two or more agents or by a single agent 1200; the predicted location, size, structure, characteristics, composition, and/or nature of an epitope; the comparative sequence identity and/or homology of a sequence of a computable epitope with one or more host sequences; and/or any putative, known, or predicted changes in a sequence of an computable epitope. The selection of computable epitopes may also depend on, for example, the type of immune response component, and/or the type and strength of its interaction, predicted to be affected by an epitope and/or by a considered treatment for managing a disease, disease state, disorder, pathology, and/or condition. The selection of computable epitopes may depend on a predicted strength of an immune response to the computable epitope or a structurally similar epitope.

In one aspect, a selected computable epitope from an agent has a probable sequence match with all or part of another agent of interest, for example an opportunistic agent or an agent associated with a subsequent or parallel infection. In another aspect, a selected computable epitope has a probable (e.g., low) match with one or more host self-epitope, for example a self-epitope known to elicit an autoimmune response. In another aspect, a selected computable epitope from an agent has a probable (e.g., high) match with one or more host self-epitopes, for example one expressed by unwanted infected cells or cancerous cells.

Continuing to refer to FIG. 13, in one aspect, for example, the sequences of selected epitopes 1306, 1312, and/or 1318 may be used to design and/or elicit one or more complementary antibodies or other immune elements 1324, 1322, and/or 1326, respectively. Complementary antibodies or other immune response elements may be purified and/or concentrated as desired, depicted as 1328, 1330 and/or 1332. The sequences of selected epitopes 1306, 1312, and/or 1318 may be used to form monoclonal antibodies, for example, by cloning or by using human-mouse systems.

In another aspect, the sequences of selected epitopes 1306, 1312, and/or 1318 may be used to elicit a cell mediated immune response. The cell mediated response may be generated in vivo or ex vivo, for example, by loading the patients immune response components, such as antigen presenting cells with one or more forms of the selected epitope in order to prime them. Such primed forms of the immune response components, may provide long term immunity, or activate other components to provide protective immunity.

The term “host,” as used herein, may include but is not limited to an individual, a person, a patient, a mammal, an avian, and/or virtually any organism possessing an immune system, including a functional, artificial, allographic, compromised, or deficient immune system. For example, a selected computable epitope may have a 0-10%, 0-20%, 0-30%, 0-40%, 0-50%, 0-60% and/or 0-70% sequence match at the amino acid level with a host, or a 0-10%, 0-20%, 0-30%, 0-40%, 0-50%, 0-60%, 0-70%, 0-80%, 0-90% and/or 0-100% sequence match at the amino acid level with an agent. Those having ordinary skill in the art will recognize that part of the context in relation to the term “host” is a practicably close sequence match to an agent (e.g., HIV-1 or influenza virus type A), so that attack by one or more immune system component could be at a sequence that has a practicably-distant match to a host sequence (e.g., that of a human patient) and would elicit little or no effect against the host. However, it is also to be understood that, in some contexts, an agent can in fact constitute a part of a host (e.g., a malfunctioning part of a host, such as in an autoimmune or neoplastic cell), in which case that part of the host will be considered the “agent,” and the part of the host to be left relatively undisturbed will be considered the “host.” In another aspect, the computable epitope selected has a sequence match with an agent, for example, a high sequence match, or a relatively higher sequence match with other agents compared to that with a host, or a 0-10%, 0-20%, 0-30%, 0-40%, 0-50%, 0-60%, 0-70%, 0-80%, 0-90%, and/or 0-100% sequence match with an agent. The term “sequence match,” as used herein, includes predicted matching of all or part of one or more sequence of nucleic acids, amino acids, monosaccharides, polysaccharides, lipid moieties, fatty acids, and/or oligopeptides, and/or any combinations thereof. In some embodiments, the computable epitope selected has a probable (e.g., low) sequence match with the host. In other embodiments, the computable epitope selected has a high sequence match with other agents.

It will be appreciated by those skilled in the art that a selected computable epitope need not be limited to a matching sequence displayed by the agent. In one aspect, one or more meta-signatures and/or consensus sequences may be derived based on any number of criteria. In one aspect, a meta-signature may be derived by analysis of data regarding, for example, antigenic evolution, genetic evolution, antigenic shift, antigenic drift, crystal structure analysis, probable match with a host, probable match with other strains, and/or strength of the immunogenic response desired. A meta-signature may include new sequences and/or may exclude some sequences. For example, a meta-signature may include silent mutations, mismatches, a spacer to bypass a hotspot or a highly mutagenic site, predicted changes in the sequence, and/or may include computable epitopes from multiple agents, thus predicted to provide protection from multiple agents. As another example, a meta-signature may exclude sequences, such as, for example, including, but not limited to, mutagenic sequences and/or sequences with a high percent sequence match to a host sequence.

In one aspect, a meta-signature may include sequences predicted to match adjacent and/or contiguous sequences. In another aspect, a meta-signature may include sequences predicted to be non-adjacent. Additionally, it will be appreciated that a meta-signature may include sequences predicted as displayed on two different parts of an agent. For example, non-adjacent sequences in a linear protein sequence may become adjacent to each other when the protein is folded. In this aspect, identification of a meta-signature may include sequences that are predicted to be non-adjacent. Furthermore, a meta-signature may include non-adjacent sequences corresponding to a specific predicted conformational state of a protein. Immune response components designed to bind such sequences may be specific to a predicted conformational state of a protein. A meta-signature may include information regarding the structure of a protein and/or the proteolytic cleavage sites and/or strength, for example information regarding proteasomal cleavage and antigen and/or receptor structure. For more information, please see: Osterloh et al., Proteasomes shape the repertoire of T cells participating in antigen-specific immune responses PNAS 103, 5042-5047 (2006); and Ito et al., Three Immunoproteasome-Associated Subunits Cooperatively Generate a Cytotoxic T-Lymphocyte Epitope of Epstein-Barr Virus LMP2A by Overcoming Specific Structures Resistant to Epitope Liberation Journal of Virology 80: 883-890 (2006), which are incorporated herein by reference. Structural information, such as 3-dimensional and/or crystal structures of an epitope, agent, or immune response component may also be used to designate a meta-signature. See, for example, Wu et al., Design of natural killer T cell activators: Structure and function of a microbial glycosphingolipid bound to mouse CD1d, PNAS 103, 3972-3977 (2006), which is incorporated herein by reference.

In another aspect, a meta-signature may include predicted non-adjacent sequences arising from a non-linear form. For example, it will be appreciated by those of ordinary skill in the art that typical and/or nontypical proteosomal processing of an antigen with or without peptide splicing and/or extra-proteasomal processing may result in the formation of an epitope, for example, one arising from a non-linear form. In this example, proteosomal processing of an antigen or agent may result in the excision of sequences, and the transposition of non-contiguous sequences, in their original or altered sequential order, to form an epitope. Additional information may be found in: Warren et al., An Antigen Produced by Splicing of Noncontiguous Peptides in the Reverse Order, Science 313, 1444-1447 (2006); Hanada et al., Immune recognition of a human renal cancer antigen through post-translational protein splicing, Nature 427:252-256 (2004); and Vigneron et al., An antigenic peptide produced by peptide splicing in the proteosome, Science 304:587-590 (2004), which are incorporated herein by reference.

In another example, a metasignature may include one or more sequences that are associated with processing, presentation, and/or an immune response, but which are not typically accessible to such processing, presentation or immune responses. For example, the formation and presentation of an epitope may arise from autophagy and/or cross-presentation and/or other nontypical cellular processes, including internal, nonlinear, and bidirectional cleavage. An epitope may be accessible to immune response components that are otherwise unable to access such epitopes and/or be associated with a certain disease state and/or immune response, such as infection, anaplasia, cancer, tolerance, autoimmunity, and hyperimmunity. More information may be found, for example, in: Ito et al., Three Immunoproteasome-Associated Subunits Cooperatively Generate a Cytotoxic T-Lymphocyte Epitope of Epstein-Barr Virus LMP2A by Overcoming Specific Structures Resistant to Epitope Liberation, Journal of Virology, 80: 883-890 (2006); Schmid and Münz, Immune surveillance of intracellular pathogens via autophagy, Cell Death and Differentiation, 12, 1519-1527 (2005); Münz, Autophagy and antigen presentation, Cellular Microbiology 8(6), 891-898 (2006); Lee et al., Autophagy-Dependent Viral Recognition by Plasmacytoid Dendritic Cells, Science 315, 1398-1401 (2007); Neijssen et al., Cross-presentation by intercellular peptide transfer through gap junctions, Nature, 434, 83-85 (2005); Heath and Carbone, Coupling and Cross-presentation, Nature 434:27-28 (2005); Dolan et al., Dendritic Cells Cross-Dressed with Peptide MHC Class I Complexes Prime CD8+ T Cells, The Journal of Immunology, 177, 6018-6024 (2006); Harbers et al., Antibody-enhanced cross-presentation of self antigen breaks T cell tolerance, J. Clin. Invest., 117(5), 1361-1369 (2007); and Piwko and Jentsch, Proteasome-mediated protein processing by bidirectional degradation initiated from an internal site, Nature Structural and Mol. Biol., 13(8), 691-697 (2006), which are incorporated herein by reference.

In one aspect, the meta-signature may include multiple sets of epitopes targeting a predicted pattern change and/or an observed pattern change. For example, multiple sets of epitopes may be designed to predict avenues of vaccination and/or production of immune response components.

Multiple techniques for epitope mapping are known. For example, information from biochemical and/or molecular studies may be used to investigate the predicted binding of at least one immune response component, including a B cell receptor, T cell receptor, antibody, and/or presentation molecule such as an MHC or CD1 molecule, to one or more agents that include at least a portion of the computable epitope. Information from Scatchard analysis and similar techniques may be used to predict the ability of an immune response component to bind a computable epitope, to determine the binding affinity of immune response component to a computable epitope, and/or to discern a desirable configuration for an immune response component. For example, see: Mayrose et al., Epitope mapping using combinatorial phage-display libraries: a graph-based algorithm, Nucleic Acids Research, 35(1), 69-78 (2007); Braga-Neto and Marques, From Functional Genomics to Functional Immunomics: New Challenges, Old Problems, Big Rewards, PLoS Comput Biol, 2(7): e81 (2006); Nielsen et al., The role of the proteasome in generating cytotoxic T-cell epitopes: insights obtained from improved predictions of proteasomal cleavage, Immunogenetics 57: 33-41 (2005); and U.S. Pat. No. 7,094,555 to Kwok et al, entitled “Methods of MHC class II epitope mapping, detection of autoimmune T cells and antigens, and autoimmune treatment,” which are all incorporated herein by reference.

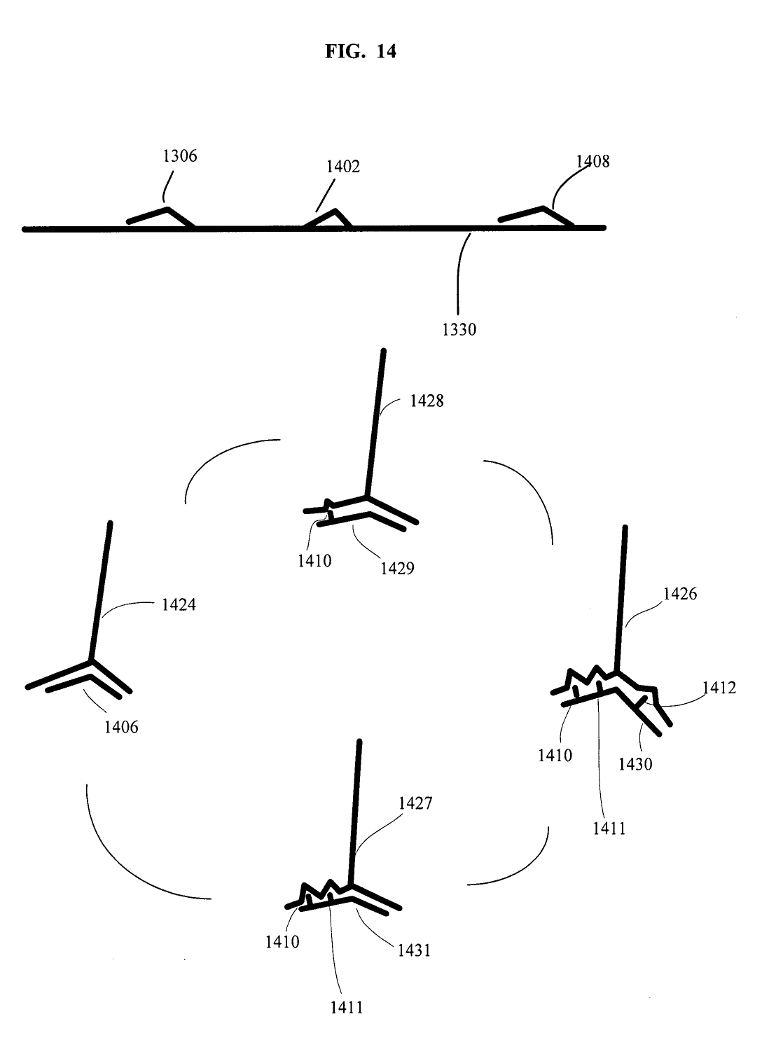

With reference to the figures, and with reference now to FIG. 14, depicted is one aspect of an antigen-antibody interaction showing the occurrence of mutational changes in a selected epitope and corresponding changes in a complementary antibody. A selected computable epitope 1306 may be predicted to undergo mutational changes. Other computable epitopes such as 1402 and/or 1408 may not be selected, for example, as the mutation rate for these epitopes may be non-predictable, extremely high, or extremely low. Mutations in computable epitopes may be random and, therefore, non-predictable, or they may be predictable. For example, a mutation may be substantially more predictable based on the occurrence of hot spots or known mutational history. A complementary antibody 1424 or other immune response component may be predicted to bind a selected computable epitope 1306, for example, with a usefully-high affinity. However, a predicted sequence change 1410 depicted in a mutated selected computable epitope 1429 may reduce the predicted binding affinity of a complementary antibody 1424 or other immune response component. A complementary antibody 1428 or other immune response component incorporating a mutation may restore predicted binding affinity, for example, to a usefully-high binding affinity. Similarly, appearance of predicted mutations such as 1410, 1411 and 1412 may require a new complementary antibody 1426 or other immune response component in order to attain a usefully-high binding affinity. Additionally, the appearance of mutations such as 1410 and 1411 may require a new complementary antibody 1427 or other immune response component. The predictive aspect of the computer system, software and/or circuitry may be used to make mathematically predictable hypotheses regarding the variations and the treatment components required. In one aspect, a complementary antibody or other immune response component need not have a predicted high binding affinity. For example, a new antibody 1426 or other immune response component may be predicted to bind and modulate agents with mutations such as 1410, 1411 and/or 1412.

In another aspect, antibodies or other immune response components with high binding affinities may be selected. Information considered in the selection may be associated with numerous techniques utilized for enhancing the binding affinity of antibodies, or other immune components, for an epitope. In one example, the binding affinity of an antibody or other immune response component for an epitope may be enhanced by constructing phage display libraries from an individual who has been immunized with the epitope either by happenstance or by immunization. The generation and selection of high affinity antibodies may also be improved, for example, by mimicking somatic hypermutagenesis, complementarity-determining region (CDR) walking mutagenesis, antibody chain shuffling, and/or technologies such as Xenomax technology (available from Abgenix, Inc., now a division of Amgen Inc., and having corporate headquarters in Fremont, Calif. 94555). In one example, antibodies or other immune response components including introduced mutations may be displayed on the surface of a filamentous bacteriophage. Processes mimicking a primary and/or secondary immune response may then be used to select desired antibodies or immune response components, for example, antibodies displaying a higher binding affinity for the antigen, and/or by evaluating the kinetics of dissociation. For additional information see: Low et al., Mimicking Somatic Hypermutation: Affinity Maturation Of Antibodies Displayed On Bacteriophage Using A Bacterial Mutator Strain, J. Mol. Biol. 260, 359-368 (1996); and Hawkins et al., Selection Of Phage Antibodies By Binding Affinity, Mimicking Affinity Maturation, J. Mol. Biol. 226, 889-896 (1992), which are incorporated herein by reference.

In another example, the generation of high affinity TCRs or antibodies may be accomplished by using a yeast surface display system. Additional information may be found in: Holler et. al., In vitro evolution of a T cell receptor with high affinity for peptide/MHC, PNAS, 97(10) 5387-5392 (2000); and Boder et. al., Directed evolution of antibody fragments with monovalent femtomolar antigen-binding affinity, PNAS 97 (10) 10701-10705 (2000), which are incorporated herein by reference.

In another example, the generation and/or selection of high affinity antibodies or other immune response components may be carried out by CDR walking mutagenesis, which mimics a tertiary immune selection process. For example, saturation mutagenesis of the CDRs of an antibody may be used to generate one or more libraries of antibody fragments which are displayed on the surface of filamentous bacteriophage followed by subsequent selection of one or more relevant antibodies using immobilized antigen. Sequential and parallel optimization strategies may be used to further select high affinity antibodies or other immune response components. For additional information see Yang et al., CDR Walking Mutagenesis For The Affinity Maturation Of A Potent Human Anti-HIV-1 Antibody Into The Picomolar Range, J. Mol. Biol. 254(3), 392-403 (1995), which is incorporated herein by reference.

In yet another example, site-directed mutagenesis may be used to predict and select high affinity antibodies or other immune response components, for example, by parsimonious mutagenesis. In this example, a computer-based method is used to identify and screen amino acid residues included in one or more CDRs of a variable region of an antibody involved in an antigen-antibody binding. Additionally, in some implementations, the number of codons introduced is such that about 50% of the codons in a degenerate position are wild-type. In another example, chain-shuffling may be used to generate and select predicted high affinity antibodies or other immune response components.

The suggested or predicted dosage of a designated epitope and/or immune response component may vary and, in one aspect, may depend, for example, on user-specified parameters such as duration of a treatment, body mass, severity of disease, and/or age in a particular embodiment. Compositions including a designated epitope and/or an immune response component may be suggested for delivery to an individual for prophylactic and/or therapeutic treatments. In one aspect, it may be suggested that an individual having a disease, disease state and/or condition may be administered a treatment dose to alleviate symptoms.

In another aspect, a person's resistance to disease conditions may be predicted to be enhanced by providing a prophylactically measured dose of an antibody or immune response component. A prophylactic dose may be suggested or predicted for, including, but not limited to, a person genetically predisposed to a disease and/or condition, a person being present in a region where a particular disease is prevalent, and/or a person wishing to enhance that person's immune response.

Optimization of predicted physico-chemical properties of an immune response component may be improved, for example, by computer-based screening methods. Predicted properties affecting antibody or immune response component therapeutics may also be improved, such as, for example, stability, antigen binding affinity, and/or solubility. Additional information may be found in U.S. Patent Application No. 2004/0110226 to Lazar, entitled “Antibody optimization,” which is incorporated herein by reference.

With reference to the figures, and with reference now to FIGS. 12, 13 and 14, depicted is one aspect of an antigen-antibody or antigen-immune response component interaction showing the occurrence of mutational changes in a selected computable epitope 1306 and corresponding changes in a complementary antibody or other immune response component 1324. Such predicted mutational changes in a selected computable epitope 1306, for example, may be minor or major in nature. These minor and/or major antigenic variations may be predicted to render an existing treatment less effective. Thus a predicted effective treatment therapy for a disease, disease state or disorder may include one or more antibodies or other immune response components designed by anticipating one or more predictable antigenic variants, for example, including, but not limited to, one or more agents or one or more related agents, and/or antigenic variants shared with at least two agents. Furthermore, predicting the course of the minor and/or major antigenic variations of an agent and/or related agents would also be beneficial in designing or selecting these one or more anticipatory immune response components. Additionally, in some implementations the inclusion of information from single nucleotide polymorphism (SNP) databases is helpful in anticipating and/or designing antibodies or other immune response components predicted to bind a selected epitope.

Minor changes in an epitope 1202, which do not always to lead to the formation of a new subtype, may be caused, for example, by point mutations in a selected epitope 1306. In one aspect, the occurrence of point mutations may be localized, for example, to hotspots of a selected epitope 1306. The frequency, location and/or occurrence of such hotspots may be predicted by a computer-based method. Additionally, a computer-based method may provide for access to one or more databases including, for example, historical compilations of the antigenic variations of an agent and/or of a selected epitope, for example, from previous epidemics and/or pandemics or the natural evolutionary history of the disease. Such information may be part of a computable epitope profile for charting the progression of the immune response. For example, including, but not limited to, a point mutation in the glutamic acid residue at position 92 of the NS1 protein of the influenza-A virus that has been shown to dramatically down-regulate activation of host cytokines. Such information may be useful in designating a meta-signature.

Continuing to refer to FIGS. 12, 13 and 14, depicted is a predicted mutation 1410 in the selected computable epitope 1306 that results in a predicted mutated epitope 1429. The term “selected epitope” 1306 as typically used herein, may represent a type of “presented epitope,” unless context indicates otherwise. A mutated epitope 1429 may be predicted to exhibit reduced binding to an immune response component, for example an antibody 1424. In one aspect, a mutated epitope 1429 could be predicted to exhibit enhanced binding to an immune response component, for example an antibody 1428, corresponding to the mutation 1410. The frequency of minor antigenic variations may be predicted by examining known and/or predicted mutational hot spots. For example, additional mutations such as 1411 and/or 1412 may be predicted by a computer-based method, and corresponding antibodies 1426 and/or 1427 or other immune response components may be designed to account for such antigenic variations in mutated computable epitopes 1430 and/or 1431, respectively. In one aspect, a predicted effective treatment therapy may incorporate antigenic variations in the course of providing an effective protective response towards an agent. For example, a predicted cocktail of immune response components may include antibodies, such as 1424, 1428, 1426, and/or 1427, and/or other immune response components predicted to bind to a selected computable epitope 1306 and/or its predicted mutated versions. In one aspect, a predicted cocktail of one or more antibodies or other immune response components may further include additional chemicals, drugs, growth factors and/or immune response modulators. In another aspect, a predicted effective treatment therapy may include varying the doses of immune response components, for example, a substantially larger or more prolonged or earlier- or later-administered dosage of antibody, such as 1426, relative to that of other antibodies, such as 1424, 1428, and/or 1427. In yet another aspect, a predicted effective treatment therapy may include versions of a designated epitope capable of modulating at least a part of an agent and/or include mutations in combination with other immune response components, for example a designated epitope and/or a designated associated protein used to load a host's dendritic cells, which may subsequently be injected into the host.

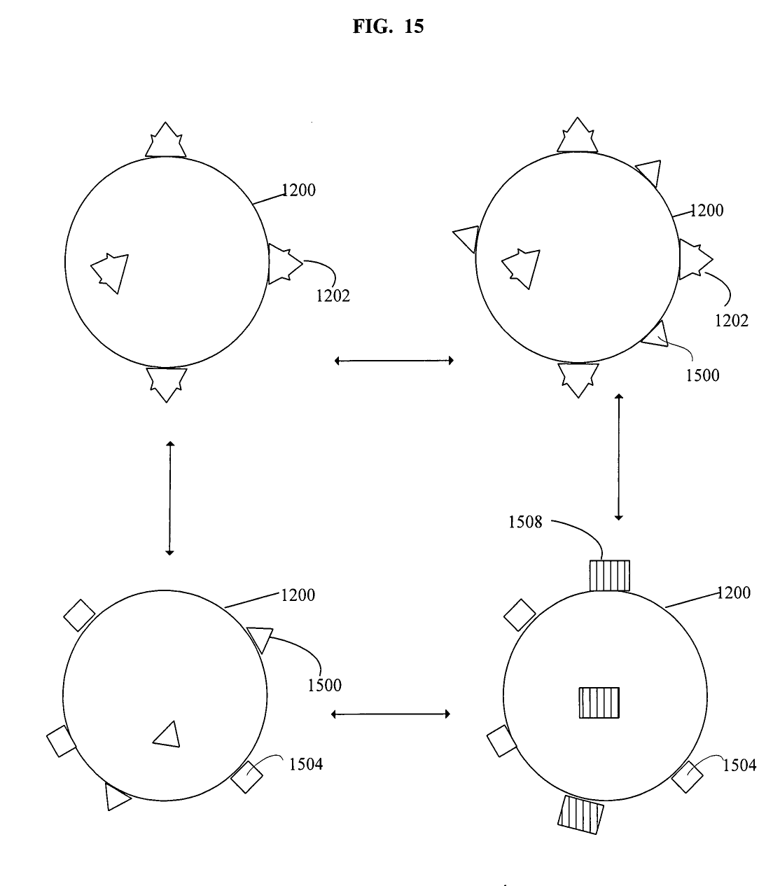

Referring now to FIG. 15, depicted is an illustration of one aspect of predicted mutational changes in an epitope displayed by an agent and corresponding changes in an immune response component. For example, one or more new epitopes 1500 and/or 1504 may appear on the surface of an agent 1200. In one aspect, major changes may be predicted to occur in an antigen present on the surface of an agent 1200, resulting in the formation of one or more new subtypes or sub-strains of an agent with at least one novel epitope 1508. The predicted appearance of new epitopes, for example, may occur as a result of antigenic shift, reassortment, reshuffling, rearrangement of segments, and/or swapping of segments, and may mark the appearance of one or more new virulent and/or pathogenic (sub-)strains of an agent 1200. In one instance, the prediction of one or more new epitopes may mark the emergence of one or more new (sub-)strains, new subtypes, and/or the reemergence of one or more older (sub-)strains. In this instance, a natural and/or artificial immune response in an individual alone may be predicted to not provide adequate protection. Immune protection, including cell mediated and/or humoral protection, may be suggested to be supplemented, for example with drugs, chemicals, or small molecules capable of enhancing, supplanting, supplementing, or favorably interacting with one or more pertinent immune response component and/or effects thereof.

In some instances when major epitopic and/or antigenic changes occur, a large section of the impacted population succumbs to an infection, sometimes leading to an epidemic and/or pandemic. This problem may be alleviated in part, for example by predicting the appearance of new (sub-)strains and/or subtypes as a result of the appearance of new epitopes and/or the disappearance of epitopes. In one aspect, for example, including but not limited to the prediction of new epitopes, attention may be directed towards a subset of genes, for example, those associated with the overall Darwinian fitness and/or replicative ability and/or infectivity of an agent. For example, examining the appearance of new subtypes of Influenza virus type A shows that antigenic variations occur for the most part as a result of mutations in the neuraminidase and/or hemagglutinin genes.

In another aspect, a selected computable epitope 1306 may avoid highly variable regions and focus instead on areas having a lower probability of mutations. Thus computable epitopes selected may circumvent hot spots of antigenic variation and target other specific regions of an agent 1200, such as, for example, receptor-binding site(s) on the surface of an agent 1200. In another example, a selected computable epitope 1306 may not be readily accessible to an immune response component; for example, the receptor-binding site may be predicted to be buried deep in a ‘pocket’ of a large protein and surrounded by readily accessible sequences exhibiting higher level(s) of antigenic variation(s). In this example, one suggested strategy may include providing small antibody or other immune response component units that penetrate the receptor-binding site and/or prevent the agent 1200 from binding to its target. In another example, one or more drugs and/or chemicals may be suggested for modification and/or enhancement of the accessibility of the receptor-binding site. In yet another example, a chemical with a tag may be suggested to bind to a receptor and the tag then predicted to bind an immune response component.

In another aspect, an immune response component may be designed so as to circumvent shape changes in the computable epitope 1202 and provide sufficiently effective binding to the epitope 1202, even following mutational change therein. In this example, the antibody or other immune response component designed may include accommodations in its design arising from the prediction of hot spots and/or the mutational changes in the epitope 1202.

In one aspect, the predicted size of an immune response component may be manipulated. An immune response component, for example an antibody 1204, may be designed to include the practicably minimal binding site required to bind an epitope 1202. In another example, an immune response component may be designed for binding to the smallest effective determinant. An immune response component may also be designed for increased size, such as, for example, by linkage to one or more proteins. An immune response component may be designed for immobility, such as, for example, by linkage to a solid substrate.

In one aspect, a suggested effective treatment therapy towards a disease and/or disorder may include one or more immune response components designed to anticipate and/or treat antigenic drift(s) and/or antigenic shift(s) predicted for multiple agents. The agents need not be related to each other; for example, the therapy might be designed for an individual suffering simultaneously from multiple diseases.

In one aspect, a suggested effective treatment therapy may include components that are predicted to elicit both cell mediated immune response and humoral immune response so as to provide maximum benefit to the host.

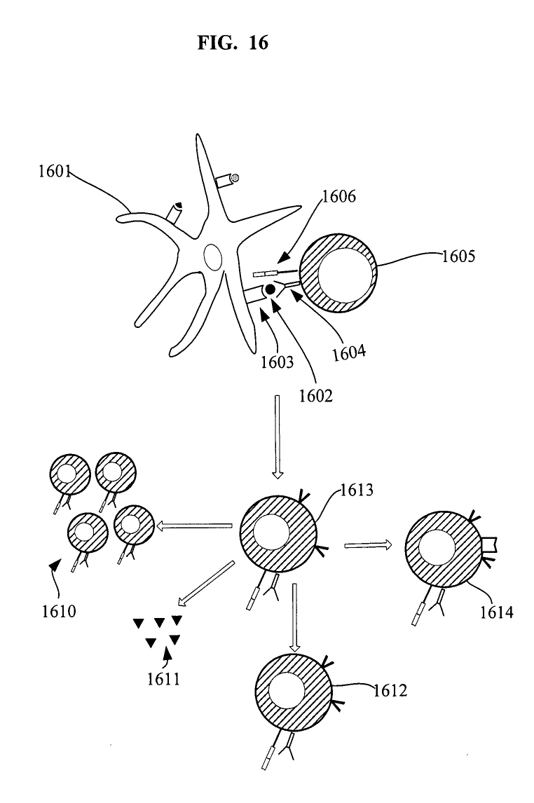

With reference now to the Figures, and with reference to FIG. 16, depicted is a diagrammatic view of one aspect of a protective response, for example a cell mediated immune response. Depicted is the activation, maturation, and/or differentiation of a T cell in response to antigen stimulation. An antigen presenting cell (APC) 1601 may process an agent that has been engulfed, such as during an innate immune response, or otherwise incorporated, such as by infection. Examples of such APC include but are not limited to dendritic cells, macrophages, B cells, and gamma delta T cells (see Brandes et al., Professional Antigen-Presentation Function by Human γδ T Cells, Science, 309(5732):264-268 (2005) and Modlin and Seiling, Now Presenting: γδ T Cells, Science 309, 252-253 (2005), which are hereby incorporated by reference), as well as specialized tissue-resident cells, some deriving from dendritic cells or macrophages. An APC 1601 may display on its cell surface at least one processed antigen 1602 in association with a presenting molecule 1603, for instance a MHC Class I or Class II molecule or a CD1 molecule. A processed antigen 1602 in association with a presenting molecule 1603 may be recognized by at least one T cell receptor (TCR) 1604 of a T cell 1605, which may also have expressed on its surface at least one receptor 1606 capable of recognizing a presenting molecule 1603. Such a bound T cell 1605 may then become activated, as when provided with a costimulatory signal from the APC 1601. A so-activated T cell 1613 may undergo maturation and/or may proliferate into progeny cells 1610, and/or produce factors 1611, such as cytokines, that are capable of influencing the T cell itself or influencing other cells. A so-activated T cell 1613 or one or more progeny 1610 may also or instead differentiate, for example into one or more effector cell 1612, and/or become a memory cell 1614, which may later become activated and proliferate and/or it or its progeny become an effector cell 1612. The generation and expansion of such memory T cells can be of importance in promoting long term immunity.

In one example, a T cell 1605 may be of a type that expresses at least one receptor 1606 that is a CD4 receptor, and a TCR 1604. A CD4+ T cell may interact with an APC 1601, such as a dendritic cell or a macrophage that has been activated by one or more bacteria or component thereof and/or one or more cytokine. Receptors on the CD4+ T cell may bind to at least one presented MHC Class II molecule and its associated processed antigen via one or more CD4 and TCR, respectively. Such a bound CD4+ T cell might then become stimulated, as when provided with one or more costimulatory signal such as that provided by the binding of cell surface molecules like CD28 binding to B7. A so-activated CD4+ T cell might then proliferate and/or it or its progeny may differentiate into a primed helper T cell, which may be of type 1 (T_{H1}) or type 2 (T_{H2}), and/or become a memory cell, which may later become activated and proliferate and/or it or its progeny become an effector cell.

In one example, a T cell 1605 may be one that expresses at least one receptor 1606 that is a CD8 receptor. A CD8+ T cell may interact with an infected APC, such as a dendritic cell carrying a virus, and bind to antigen presented by the APC on one or more presenting MHC Class I molecule via one or more TCR and CD8, respectively. Such a bound CD8+ T cell might become stimulated, as when provided with a costimulatory signal, then proliferate, and/or it or its progeny differentiate into one or more effector cytotoxic T lymphocyte (CTL) and/or become a memory cell 1614, which may later become activated and proliferate and/or it or its progeny become an effector cell.

In one example, a T cell 1605, which may or may not express CD4 and/or CD8, can interact with an APC 1601, such as a dendritic cell that has interacted with and/or internalized and processed all or part of a microbe. An APC 1601 might present an antigen 1602 that is a lipid, which may be a glycolipid, phospholipid, or sphingolipid, or a hydrophobic peptide, on a presenting molecule 1603 that is a CD1 molecule. Such a T cell might, for instance, be an invariant Natural Killer (NK) T cell, or NK 1.1 T cell, expressing a TCR as well as surface molecules common to natural killer cells, which are lymphocytes that are neither B nor T cells. More information can be found in: De Libero and Mori, Recognition of Lipid Antigens by T Cells, Nature Reviews Immunology, 5(6), 485-96 (2005); De Libero, How T lymphocytes recognize lipid antigens, FEBS Lett., 580(23), 5580-5587 (2006); Thurnher, Lipids in dendritic cell biology: messengers, effectors, and antigens, J. Leukoc. Biol. 81: 154-60 (2007); Young and Moody, T-cell recognition of glycolipids presented by CD1 proteins, Glycobiology 16:103 R-112R (2006); Russano et al., CD1-Restricted Recognition of Exogenous and Self-Lipid Antigens by Duodenal γδ T Lymphocytes, Journal of Immunology, 178: 3620-3626 (2007); Wahl et al., Type I IFN-Producing CD4 Vα14i NKT Cells Facilitate Priming of IL-10-Producing CD8 T Cells by Hepatocytes, Journal of Immunology 178: 2083-2093 (2007), and Brutkiewicz, CD1d Ligands: The Good, the Bad, and the Ugly1, Journal of Immunology, 177:769-775 (2006); which are incorporated herein by reference. Such a T cell might be stimulated to proliferate and/or it or its progeny differentiate into an effector cell, and/or become a memory cell. Such an NK1.1+T cell might become activated and may produce, and in some cases release, factors that may affect the cell itself or affect other cells. For example, a stimulated NK1.1+T cell might release a cytokine like IL4 that drives differentiation of CD4+ T cells to become T_{H2} cells, which in turn may induce B cells to undergo class switching to produce IgE. Or, in another example, a primed lipid-specific T cell may recognize and bind to a dendritic cell infected with a pathogen like M. tuberculosis and function to kill the pathogen.

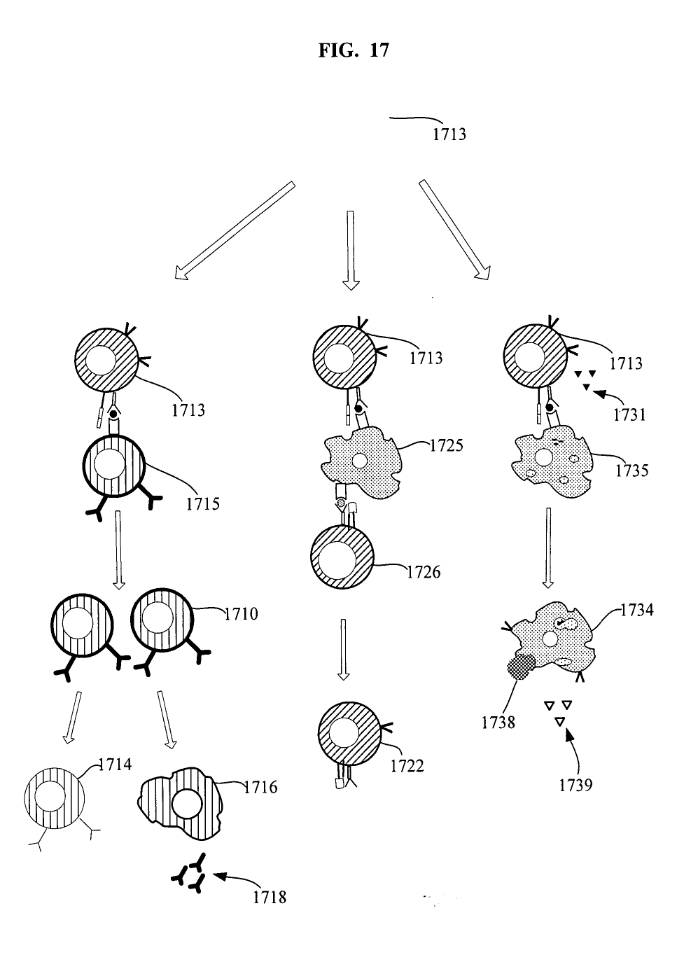

A primed CD4+ helper T cell can affect many other cell types. Continuing to refer to FIG. 16 and referring to FIG. 17, as one example, following an interaction between a T cell 1605 that is a helper T cell and an APC 1601, the so stimulated T cell 1613 would be a primed CD4+ helper T cell 1713. A primed CD4+ helper T cell 1713, which may be a T_{H2} cell, may interact with a B cell 1715 that has encountered an agent via its B cell receptor (BCR), engulfed the receptor-agent complex, degraded and processed the agent, and is presenting a related antigen complexed on its MHC Class II molecule. A primed CD4+ helper T cell 1713 recognizes an antigen-MHC complex on a B cell 1715 via TCR and CD4 receptors. Binding stimulates the helper T cell 1713, which produces, and in some cases releases, factors, including cytokines, that are capable of influencing the B cell 1715 and/or other cells. A so-activated B cell may proliferate to produce progeny 1710, which may undergo molecular changes such as antibody class switching, and/or become one or more memory cell 1714 or plasma cell 1716 that secretes antibodies 1718. Such antibodies 1718 may be capable of providing humoral protection to the user. Additional information may be found in Roitt's Essential Immunology, (11th edn) by Ivan M. Roitt, Seamus J. Martin, Peter J. Delves, Dennis Burton, Blackwell Publishing; Immunobiology: The Immune System in Health and Disease (6th edn) by Charles Janeway, Paul Travers, Mark Walport & Mark Shlomchik, Garland Science; and Bradley et al., Characterization Of Antigen-Specific CD4+ Effector T Cells In Vivo: Immunization Results In A Transient Population Of MEL-14-, CD45RB-Helper Cells That Secretes Interleukin 2 (IL-2), IL-3, IL-4, And Interferon Gamma, J Exp Med., 174(3), 547-559 (1991), which are herein incorporated by reference.

In another example, binding of a primed CD4+ helper T cell 1713 to an APC, such as a virus-infected macrophage 1725, can stimulate the helper T cell 1713 to produce and present and/or release factors, including costimulatory factors like CD40L and/or interleukins, that are capable of activating the macrophage 1725. A so-activated macrophage might then bind to and activate, as when providing a costimulatory factor, a naïve CD8+ T cell 1726, also bound to the macrophage via its TCR and CD8. A so-activated CD8+ T cell might proliferate, and/or it or its progeny may differentiate into one or more effector CTL 1722 and/or become one or more memory cell, which may later become activated and proliferate and/or it or its progeny become an effector cell 1722. Such presentation and activation, for example, may include a response to an adjuvant as in a vaccine.

In another example, a primed helper T cell 1713, which may be a T_{H1} cell, may bind, via its TCR and CD4 molecules, to antigen presented on an MHC Class II molecule by, for example, a macrophage 1735 that has incorporated a pathogen like a parasite, bacteria, or free antigen. The bound helper T cell 1713 may be stimulated and produce and in some cases release one or more factor 1731. A released factor 1731, such as interferon, may act on the macrophage 1735 to activate the cell, and/or may be capable of acting on other cells, for instance to induce chemotaxis of other macrophages or induce the production of new monocytes/macrophages, or to induce epithelial cells to be more responsive to trafficking macrophages. An activated macrophage 1734 can destroy incorporated pathogens and/or release one or more compound 1738 to affect other cells or extracellular agents, including compounds such as radical oxygen species and/or proteases capable of destroying the agent. A so-activated phagocyte/macrophage 1734 may be responsive to and can act on additional agents of the same or other types and may also move to other sites, possibly to participate in innate or early immune responses. An activated macrophage 1734 may also produce, express, and/or release factors 1739, including cytokines and additional MHC molecules, that are capable of influencing other cells, such as other helper CD4+ T cells, which may become activated, and/or of regulating other cells.

In other examples, primed CD4+ T cells may also influence, as by one or more factor, other cell types, which might include granulocytes, natural killer cells, killer cells, myeloid cells, and epithelial cells, that can act or aid in the immune response. A signaled cell or a helper T cell, may respond by producing and/or releasing factors capable of affecting one or both of the cell types and/or one or more additional cell. Such an effect might include, but not be limited to, inducing chemotaxis and/or recruitment of cells, regulating the expression of surface molecules and/or regulating differentiation or proliferation. Functions of certain cells may be affected, including phagocytosis, elimination or destruction of intracellular pathogens, direct elimination and/or destruction of cells. More information can be found in Roitt's Essential Immunology, (11th edn) by Ivan M. Roitt, Seamus J. Martin, Peter J. Delves, Dennis Burton, Blackwell Publishing; Immunobiology: The Immune System in Health and Disease (6th edn) by Charles Janeway, Paul Travers, Mark Walport & Mark Shlomchik, Garland Science; and Scott et al., An anti-infective peptide that selectively modulates the innate immune response Nat. Biotechnol. 25(4):465-72 (2007), which are incorporated herein by reference.

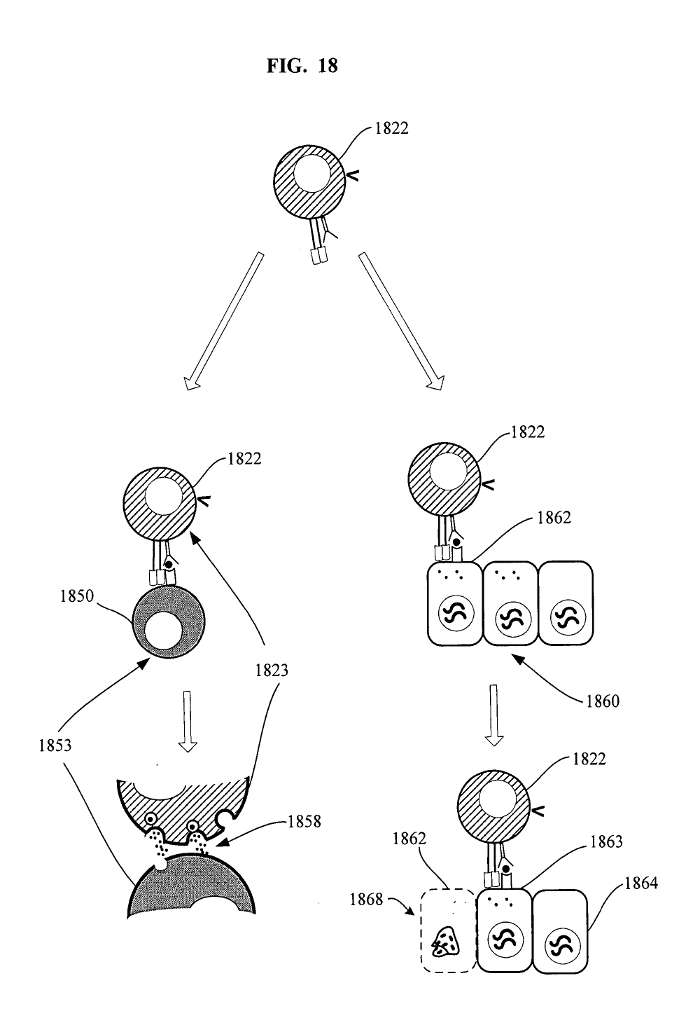

A CD8+ T cell may become activated and differentiate into a CTL. Referring now to FIG. 18 and referring back to FIG. 16 and FIG. 17, a T cell 1605 that is a CD8+ T cell might become activated, for example upon interacting with an infected APC 1601, or, in another example, a nafve CD8+ T cell 1725 may interact with an activated macrophage 1725, possibly with help from a CD4+ helper T cell 1713, for instance when exposed to an adjuvant in an immunization. Once stimulated by any such method, a primed antigen-specific CTL 1722/1822 might recognize antigen displayed on one or more other cell or an agent and act to affect the cell or agent by, for example, expressing and/or releasing substances capable of lysing or otherwise destroying the target or inducing its destruction. As an example, a CTL 1822 may recognize an antigen on a cell 1850 and may undergo structural changes including changes in its membrane 1823 and may release molecules 1858, such as performs, capable of affecting the cell 1850, as by perforating its membrane and destroying it.

In another example, a CTL 1822 may recognize an antigen on one of a group of cells, such as one infected epithelial cell 1862 of an epithelial cell layer 1860, and act to affect the cell by, for example, expressing and/or releasing substances capable of destroying a target cell or inducing its destruction. For instance a CTL 1822 might provide factors, including Fas Ligand and/or one or more granzyme, capable of inducing apoptosis 1868. Such a CTL 1822 might be able to act serially to affect more than one cell 1862 and move to target an adjacent cell 1863. A CTL 1822 might instead or also affect infected cells 1862 and 1863 without targeting adjacent uninfected cells 1864. A CTL might also produce and/or release factors such as cytokines, including one or more interferon (IFN), able to affect other cells, including macrophages, which may then aid in the response. More information can be found in Roitt's Essential Immunology, (11th edn) by Ivan M. Roitt, Seamus J. Martin, Peter J. Delves, Dennis Burton, Blackwell Publishing; Immunobiology: The Immune System in Health and Disease (6th edn) by Charles Janeway, Paul Travers, Mark Walport & Mark Shlomchik, Garland Science, Busch and Pamer, T Cell Affinity Maturation by Selective Expansion during Infection, J. Exp. Med. 189: 701-709 (1999); Marguiles, TCR avidity: it's not how strong you make it, it's how you make it strong, Nat. Immunol. 8:669-70 (2001); and Slifka and Whitton, Functional avidity maturation of CD8(+) T cells without selection of higher affinity TCR, Nat. Immunol. 8:711-7 (2001).

In one aspect, memory T cells against one or more computable epitopes may be predicted to be generated by displaying the physical structure corresponding to a computable epitope on an acceptable carrier. In another aspect, the physical structure associated with a computable epitope may be predicted to generate central memory T cells. In yet another aspect, the physical structure associated with a computable epitope may be predicted to stimulate at least a part of a T cell mediated pathway and/or a B cell mediated pathway. Designating a computable epitope with an associated physical structure predicted to bind to a T cell may be carried out, for example, using MHC binding motif density and AMPHI algorithms. A designated computable epitope may include pattern changes predicted to generate T cells primed for future mutable forms of an agent, for example, a virus such as HIV-1 or Influenza virus type A.

In one aspect a predicted evocation of a cell mediated immune response may be associated with providing protection to a host, for example, by activation of antigen-specific cytotoxic T cells. Such T cells may bind to an antigen, for example, an antigen displayed on the surface of an agent, followed by lysis of the agent. In another aspect an evocation of a cell mediated immune response may be predicted to provide protection to a host, for example, by activation of macrophages and natural killer cells followed by the subsequent removal of an agent. In yet another aspect, an evocation of a cell mediated immune response may be predicted to provide protection to a host, for example, by secretion of one or more cytokines that influence the function of cells involved in the adaptive immune response and/or the innate immune response.

In one aspect, evocation of a cell mediated response may be predicted to include delayed type hypersensitivity (DTH). Memory T helper cells may produce cytokines on exposure to an antigen and cytokines may recruit and activate cytotoxic T cells and/or inflammatory cells such as macrophages. DTH may be perceived as an indicator for T cell response to an antigen, for example in a tuberculin skin reaction test. In one aspect, a designated epitope including one or more pattern change for modulating at least a part of an agent may be used to predict a T cell response in a host, for example, following inoculation of a host with a physical structure associated with at least one computable epitope. Other types of hypersensitivity such as type I, type II and/or type III are antibody mediated, and can include signaling from T helper cells. An inflammatory response associated with hypersensitivity can be induced by exposure to soluble or matrix-associated antigens. Alleviation of inflammation may be predicted to be associated in part by at least one designated epitope or related peptide and/or protein, for example, one capable of inhibition of crosslinking or blocking the Fc portion of IgE antibodies and decreasing their affinity for mast cells and/or basophils.

In one aspect, the display of CD4 receptors by helper T cells mediates binding to MHC Class II molecules present on the surface of other cells. Prediction of MHC binding peptides may help in predicting epitopes that stimulate cell mediated responses. Several algorithms have been proposed to predict MHC binding peptides. Examples include structure based prediction, motif based prediction, matrix based prediction, and artificial Neural Network based prediction. A binding affinity of a peptide for an MHC class molecule may be predicted, for example, using a Fuzzy neural network based method. Additionally, MHC class I peptides may be predicted using freely available software such as HLA_Bind.

In one aspect, the presence of a free agent in the bloodstream may lead to incorporation, for instance by engulfment, by one or more APC and subsequent presentation of antigen to T cells, possibly within a lymph node. Antigen binding may stimulate a T cell to divide and produce one or more helper T cell and/or one or more CTL. Other cell types may also be activated directly or indirectly by such T cells or factors produced and/or released by such cells. In one aspect a computable epitope may be predicted to stimulate at least a part of a T cell mediated pathway and/or B cell mediated pathway. In one aspect, disease-specific T cells may be predicted to be generated in large quantities by the use of artificial antigen presenting cells. Artificial antigen presenting cells may be formed, for example, by extracting a host's antigen presenting cells and activating them using selected epitopes and/or peptides, including those carrying pattern changes, and/or stimulating compounds, such as interferon (IFN).

In one aspect, a cellular immune response is a multi-specific response and may include a CTL and/or helper T cell responding to one or more antigens on the surface of a cell and possibly presented by an MHC or CD1 molecule. A predicted cellular response may be one directed towards an epitope present on at least a portion of an agent. Such a response may be directed towards a variable region of an antigen, which may be predicted to allow the agent to escape by generating new mutations. In one aspect a computable epitope is designed for its associated physical structure to be recognizable by cytotoxic T cells and/or helper T cells. For example, a computable epitope may be designed for presentation by MHC Class I, MHC Class II, and/or CD1 molecules. Such a computable epitope may be predicted to serve as a target for cytotoxic T cells and/or helper T cells. Additionally, at least two computable epitopes may be designed as to predictably target both cytotoxic T cells and/or helper T cells. In some aspects, a computable epitope may include one or more pattern changes to prime an immune system against future mutated forms of an agent. Additionally, in some aspects, a computable epitope may be associated with use in combination with other immune response components and/or costimulatory molecules.

In one aspect, a computable prototype of a putative “infectious agent” or a “super infectious agent” may be provided. The computable prototype may include a part of an agent and may include an agent in its entirety. Such a prototype may be a predicted future mutated agent and may be designed by utilizing an available knowledge base relating to, for example, including, but not limited to, information relating to strains or subtypes of an agent, acceptable hosts for each strain or subtype of an agent, primary hosts for each strain or subtype of an agent, secondary hosts for each strain or subtype of an agent, genomic content of a host, site of integration in a host and/or agent, regions of mutability in an agent, or presence of mutagens in an environment. For example, an agent such as an influenza virus type A in a human host might be predicted to undergo mutation to evade an immune response and/or to allow transmission among a host population, a concept termed antigenic drift. Such predicted mutations, for example, might include one or more genetic mutations that result in the alteration of one or more surface proteins so that they are predicted to no longer be recognized by neutralizing antibodies. If an immune system of a human host or that of a host population can no longer respond to a surface protein, a virus may evade destruction and infect cells and/or be transmissible to a new host.

Or, in another aspect, a pathogen might be predicted to alter its genetic material by obtaining material via exchange within itself or with a neighboring organism, or by uptake, as from an environment. Examples include transformation, transposition of elements in certain bacteria, and gene transfer mechanisms such as transduction and conjugation. Alterations can lead to increased virulence within a pathogen and/or allow it to become resistant to immune responses.

In circumstances where a pathogen is predicted to mutate by any means, a predicted host immune system would have to adapt to combat an infection. A computable prototype of an agent may provide valuable information to identify, for example, new computable epitopes predicted to be capable of eliciting a protective immune response, or a level of protection needed to suppress an infection, or for designing whole antigen or whole cell vaccines.

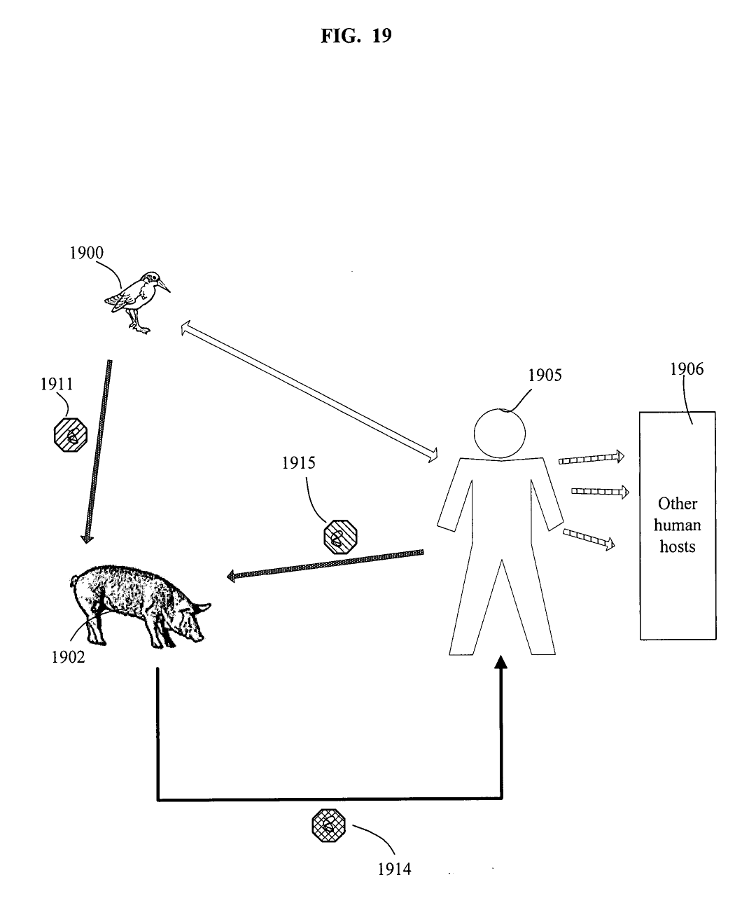

In reference now to FIG. 19, in another aspect a mutation may be more extensive, as in the concept of antigenic shift. For example, influenza virus type A may be found in a variety of animals, such as avians 1900 and mammals 1902 and 1905, although some subtypes may show species specificity. A new subtype may arise when two different subtypes encounter each other in a host, as in a secondary host. In one example, two strains of influenza virus type A, an avian strain 1911 and a strain 1915 that is transmissible between humans, both infect a secondary animal such as a pig 1902. Properties of the two viruses may combine to form, for example by reassortment of genetic material, a new virus subtype 1914, transmissible to a human host 1905. A new subtype 1914 might not be recognized by an immune system of an original or novel host, such as a human host 1905. A new strain may be highly infectious and/or may be infect one or more human host 1905 with subsequent transmission to other human hosts 1906 and have the potential of causing a pandemic. Several pandemics have been attributed to this type of antigenic drift.

Mutations such as those arising from reassortment of genetic material may also occur in a human host infected with at least two different virus strains. For example co-infection or superinfection of a human with two subtypes or distinct viruses of the Human Immunodeficiency Virus (HIV) might result, for example, in circulating recombinant forms (CRF) of the virus capable of transmission and infection (HIV sequence database http://www.hiv.lanl.gov/content/hiv-db/CRFs/CRFs.html; HIV-1 Subtype and Circulating Recombinant Form (CRF) Reference Sequences, 2005 Thomas Leitner, Bette Korber, Marcus Daniels, Charles Calef, Brian Foley Los Alamos National Laboratory, Los Alamos, N. Mex. 87545 seq-info@t-10.lanl.gov http://hiv.lanl.gov/). Domain swapping is one common mechanism by which reassortment of genetic material may occur.

In one aspect, an antigenic shift may be recreated in silico by predicting or specifying the number and nature of the intermediate hosts, the number and types of strains, and/or the recombination rates between domains to create a new putative computable prototype. The predictive power of such a computable prototype may be beneficial in identifying new computable epitopes for modeling an agent, as in the event of a pandemic.

B. Operation(s) and/or Process(es)

Following are a series of flowcharts depicting implementations of processes. For ease of understanding, the flowcharts are organized such that the initial flowcharts present implementations via an overall “big picture” or “top-level” viewpoint and thereafter the subsequent flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a more rapid and reliable understanding of the various process implementations.

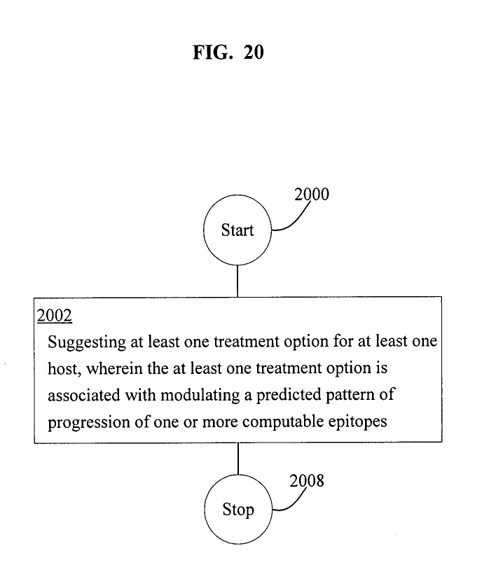

With reference now to FIG. 20, depicted is a high-level logic flowchart of a process. Method step 2000 shows the start of the process. Method step 2002 depicts suggesting at least one treatment option for at least one host, wherein the at least one treatment option is associated with modulating a predicted pattern of progression of one or more computable epitopes. Method step 2008 shows the end of the process.

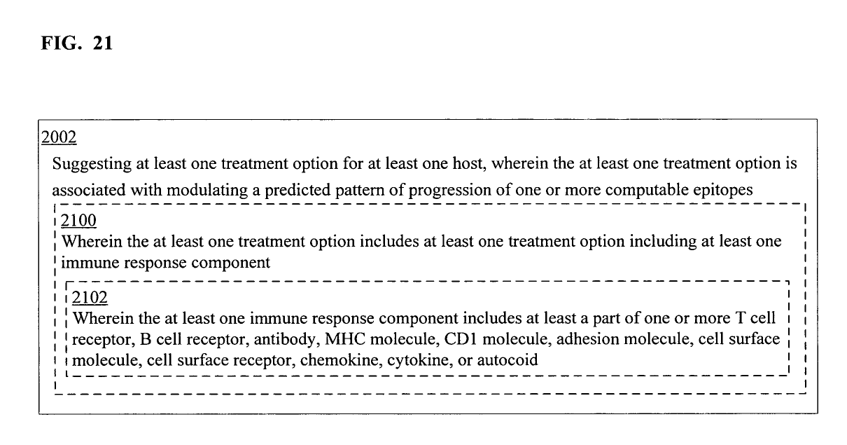

With reference now to FIG. 21, depicted is a high-level logic flowchart depicting alternate implementations of the high-level logic flowchart of FIG. 20. Illustrated is that in various alternate implementations, method step 2002 may include method step 2100 wherein the at least one treatment option includes at least one treatment option including at least one immune response component. Method step 2100 may further include method step 2102 wherein the at least one immune response component includes at least a part of one or more T cell receptor, B cell receptor, antibody, MHC molecule, CD1 molecule, adhesion molecule, cell surface molecule, cell surface receptor, chemokine, cytokine, or autocoid.

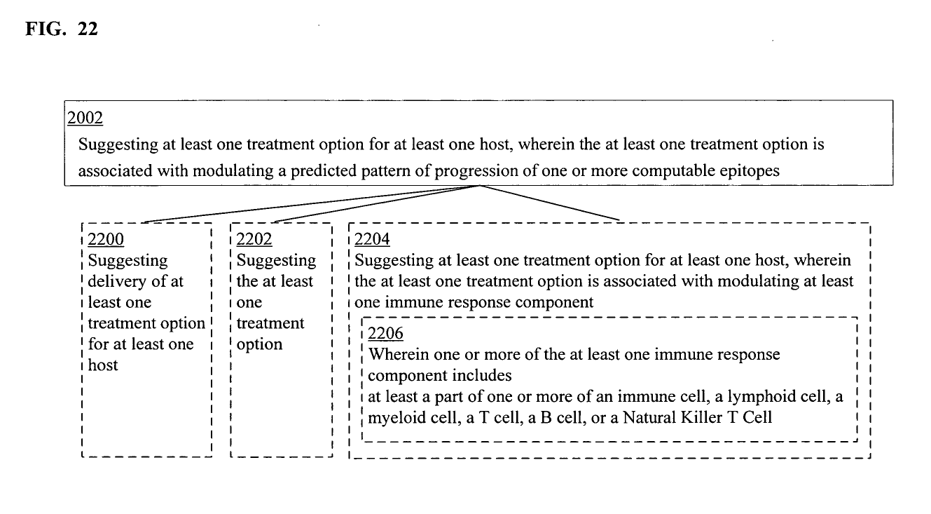

With reference now to FIG. 22, depicted is a high-level logic flowchart depicting alternate implementations of the high-level logic flowchart of FIG. 20. Illustrated is that in various alternate implementations, a method may include method steps 2200, 2202, 2204, and/or 2206. Method step 2200 depicts suggesting delivery of at least one treatment option for at least one host. Method step 2202 shows suggesting the at least one treatment option. Method step 2204 illustrates suggesting at least one treatment option for at least one host, wherein the at least one treatment option is associated with modulating at least one immune response component. Method step 2204 may include method step 2206, wherein one or more of the at least one immune response component includes at least a part of one or more of an immune cell, a lymphoid cell, a myeloid cell, a T cell, a B cell, or a Natural Killer T Cell.

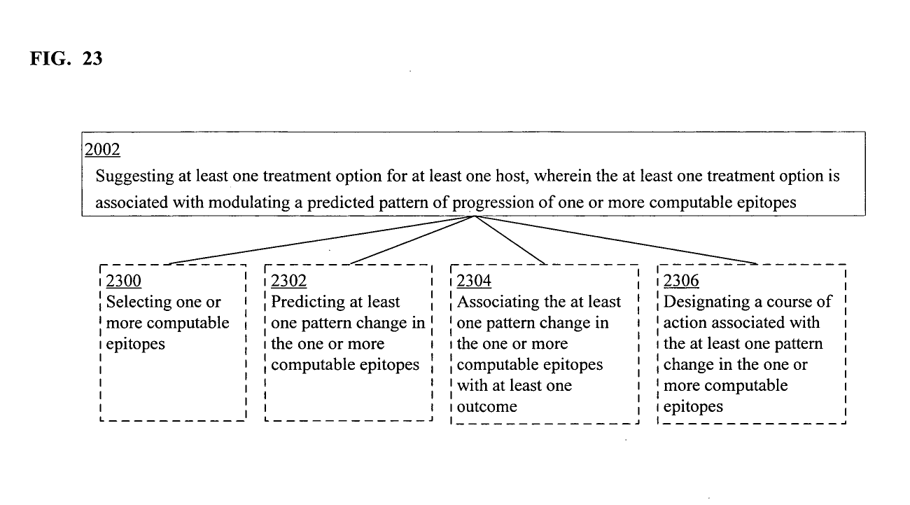

With reference now to FIG. 23, depicted is a high-level logic flowchart depicting alternate implementations of the high-level logic flowchart of FIG. 20. Illustrated is that in various alternate implementations, a method may include method steps 2300, 2302, 2304, and/or 2306. Method step 2300 illustrates selecting one or more computable epitopes. Method step 2302 depicts predicting at least one pattern change in the one or more computable epitopes. Method step 2304 shows associating the at least one pattern change in the one or more computable epitopes with at least one outcome. Method step 2306 illustrates designating a course of action associated with the at least one pattern change in the one or more computable epitopes 2306.

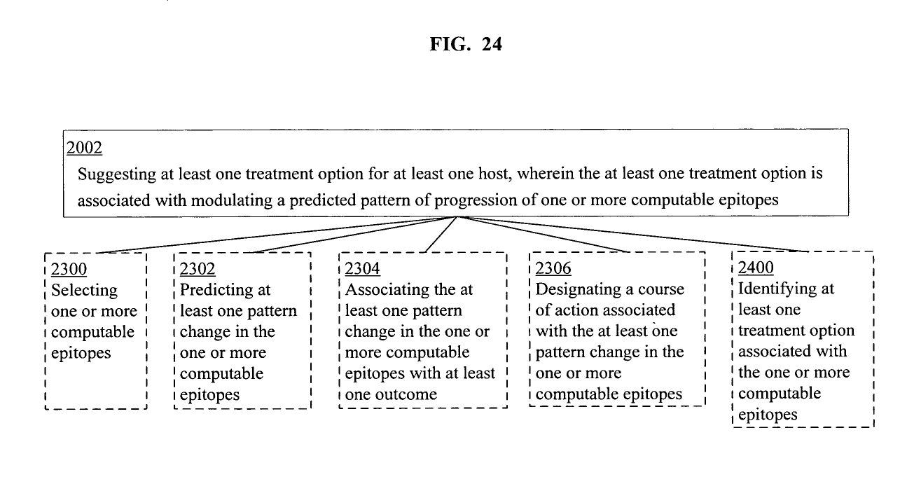

With reference now to FIG. 24, depicted is a high-level logic flowchart depicting alternate implementations of the high-level logic flowchart of FIG. 20. Illustrated is that in various alternate implementations, a method may include method steps 2300, 2302, 2304, 2306, and/or 2400. Method step 2400 illustrates identifying at least one treatment option associated with the one or more computable epitopes.

C. Variation(s), and/or Implementation(s)

Those having skill in the art will recognize that the present application teaches modifications of the devices, structures, and/or processes within the spirit of the teaching herein. For example, methods and systems described herein may be beneficial in the design and/or development of artificial antigen presenting cells which may include sequences displayed on the surface of an antigen and/or associated with a situation requiring management. Introduction of such antigen presenting cells into a host may be predicted to elicit a cell mediated or a humoral immune response. Other modifications of the subject matter herein will be appreciated by one of ordinary skill in the art in light of the teachings herein.

Those having skill in the art will recognize that the present application teaches modifications of the devices, structures, and/or processes within the spirit of the teaching herein. For example, in one aspect, the invention may include information regarding the harvesting of a host's memory T cell or other cells, such as, for example, dendritic cells, the introduction of one or more epitopes corresponding to one or more computable epitopes, and the reintroduction of primed cells back into the host. Other modifications of the subject matter herein will be appreciated by one of ordinary skill in the art in light of the teachings herein.

Those having skill in the art will recognize that the present application teaches modifications of the devices, structures, and/or processes within the spirit of the teaching herein. For example, in one aspect, computable epitopes designated may be selected in relation to a predicted form of one or more immune response components for modulating at least a part of the agent. In one aspect, an immune response component selected may include a formulation predicted to be able to cross the blood-brain barrier, which is known to exclude mostly hydrophilic compounds as well as to discriminate against transport of high molecular weight compounds. For example, an immune response component may be suggested to include a lipid component, such as, for example, an antibody fragment encased in a lipid vesicle. In another example, a selected immune response component, such as an antibody or a portion of an antibody, may include a tag such as a carrier protein or molecule. In another example, an antibody or other immune response component may be designed to be split into one or more complementary fragments, each fragment encased by a lipid vesicle, and each fragment functional only on binding its complementary fragment. In such a formulation, once the blood-brain barrier has been crossed, the lipid vesicle may be dissolved to release the antibody fragments, which may reunite with their complementary counterparts and form a fully functional antibody or other immune response component. Other modifications of the subject matter herein will be appreciated by one of ordinary skill in the art in light of the teachings herein.

Those having skill in the art will recognize that the present application teaches modifications of the devices, structures, and/or processes within the spirit of the teaching herein. For example, in one aspect, the immune response components may be developed in large format. The method lends itself to both small format and/or personalized care applications and large-scale or large format applications. Other modifications of the subject matter herein will be appreciated by one of ordinary skill in the art in light of the teachings herein.

Those having skill in the art will recognize that the present application teaches modifications of the devices, structures, and/or processes within the spirit of the teaching herein. For example, in one aspect, the method may be used to designate immune response components for any disease or disorder. The application of this method is not limited to diseases where antigenic shift or drift keeps the immune system “guessing” or causing it to be effectively slow-to-respond. Although influenza virus type A or HIV-1 are among the likely viral-disease-agent candidates for application of this method, treatment of other diseases, disorders and/or conditions will likely benefit from this methodology. Other modifications of the subject matter herein will be appreciated by one of ordinary skill in the art in light of the teachings herein.

Those having skill in the art will recognize that the present application teaches modifications of the devices, structures, and/or processes within the spirit of the teaching herein. For example, in one aspect, real-time evaluation may be provided of predicted antigenic changes by including a portable PCR machine which samples an environment for (sub)strains of infectious pathogens locally present. Information generated by the portable PCR machine may be sent remotely to another location or to a portable material-administering device, for example, a drip-patch device with a remote sensor, utilized by a potentially affected person, resulting in activation of predicted and pre-prepared immune response components and thereby providing adequate protection if-and-when the pathogen may become present in the person's location. As the evaluation possibly changes in time, the portable device may be controlled to change the dosage or type of immune response component delivered. Such a portable administering device, operably coupled to a portable PCR machine or a functionally similar system for polypeptides and/or polysaccharides, has a wide variety of applications, for example, including, but not limited to, use by medical personnel visiting an area in which one or more diseases may be endemic, and/or military personnel visiting territory in which unknown pathogens may be present. Other modifications of the subject matter herein will be appreciated by one of ordinary skill in the art in light of the teachings herein.

Those having ordinary skill in the art will recognize that the present application teaches modifications of the devices, structures, and/or processes within the spirit of the teaching herein. For example, in one aspect, an individual may use an administering device including immune response components predicted to provide the user the necessary immune response-mediated protection over an interval period of time, and/or to anticipate pattern changes in the epitopes of the agent. Other modifications of the subject matter herein will be appreciated by one of ordinary skill in the art in light of the teachings herein.

Those having ordinary skill in the art will recognize that the present application teaches modifications of the devices, structures, and/or processes within the spirit of the teaching herein. For example, in one aspect, RNA blockers, and/or single-stranded RNAi technology may be predicted to down-regulate genes or components of the immune system in conjunction with the method. Other modifications of the subject matter herein will be appreciated by one of ordinary skill in the art in light of the teachings herein.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to”, or other past-tense adjectives are generally not intended to exclude such variants, unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
at least one computer program for use with at least one computer system and wherein the computer program includes a plurality of instructions including but not limited to;
one or more instructions for suggesting at least one treatment option for at least one host, wherein the at least one treatment option is associated with modulating a predicted pattern of progression of one or more computable epitopes.

2. The system of claim 1, wherein the at least one treatment option further comprises:
at least one treatment option including at least one immune response component.

3. The system of claim 2, wherein the at least one immune response component comprises:
at least a part of one or more T cell receptor, B cell receptor, antibody, MHC molecule, CD1 molecule, adhesion molecule, cell surface molecule, cell surface receptor, chemokine, cytokine, or autocoid.

4. The system of claim 1, further comprising:
one or more instructions for suggesting delivery of at least one treatment option for at least one host.

5. The system of claim 1, further comprising:
one or more instructions for suggesting the at least one treatment option.

6. The system of claim 1, further comprising:
one or more instructions for suggesting at least one treatment option for at least one host, wherein the at least one treatment option is associated with modulating at least one immune response component.

7. The system of claim 6, wherein one or more of the at least one immune response component comprises:
at least a part of one or more of an immune cell, a lymphoid cell, a myeloid cell, a T cell, a B cell, or a Natural Killer T Cell.

8. The system of claim 1, further comprising:
one or more instructions for selecting one or more computable epitopes;
one or more instructions for predicting at least one pattern change in the one or more computable epitopes;
one or more instructions for associating the at least one pattern change in the one or more computable epitopes with at least one outcome; and
one or more instructions for designating a course of action associated with the at least one pattern change in the one or more computable epitopes.

9. The system of claim 8, further comprising:
one or more instructions for identifying at least one treatment option associated with the one or more computable epitopes.

10. A system comprising:
circuitry for suggesting at least one treatment option for at least one host, wherein the at least one treatment option is associated with modulating a predicted pattern of progression of one or more computable epitopes.

11. The system of claim 10, wherein the at least one treatment option further comprises:
at least one treatment option including at least one immune response component.

12. The system of claim 11, wherein the at least one immune response component comprises:
at least a part of one or more T cell receptor, B cell receptor, antibody, MHC molecule, CD1 molecule, adhesion molecule, cell surface molecule, cell surface receptor, chemokine, cytokine, or autocoid.

13. The system of claim 10, further comprising:
circuitry for suggesting delivery of at least one treatment option for at least one host.

14. The system of claim 10, further comprising:
circuitry for suggesting the at least one treatment option.

15. The system of claim 10, further comprising:
circuitry for suggesting at least one treatment option for at least one host, wherein the at least one treatment option is associated with modulating at least one immune response component.

16. The system of claim 15, wherein one or more of the at least one immune response component comprises:
at least a part of one or more of an immune cell, a lymphoid cell, a myeloid cell, a T cell, a B cell, or a Natural Killer T Cell.

17. The system of claim 10, further comprising:
circuitry for selecting one or more computable epitopes;
circuitry for predicting at least one pattern change in the one or more computable epitopes;
circuitry for associating the at least one pattern change in the one or more computable epitopes with at least one outcome; and
circuitry for designating a course of action associated with the at least one pattern change in the one or more computable epitopes.

18. The system of claim 17, further comprising:
circuitry for identifying at least one treatment option associated with the one or more computable epitopes.

19. A method, comprising:
suggesting at least one treatment option for at least one host, wherein the at least one treatment option is associated with modulating a predicted pattern of progression of one or more computable epitopes.

20. The method of claim 19, wherein the at least one treatment option further comprises:
at least one treatment option including at least one immune response component.

21. The method of claim 20, wherein the at least one immune response component comprises:
at least a part of one or more T cell receptor, B cell receptor, antibody, MHC molecule, CD1 molecule, adhesion molecule, cell surface molecule, cell surface receptor, chemokine, cytokine, or autocoid.

22. The method of claim 19, further comprising:
suggesting delivery of at least one treatment option for at least one host.

23. The method of claim 19, further comprising:
suggesting the at least one treatment option.

24. The method of claim 19, further comprising:
suggesting at least one treatment option for at least one host, wherein the at least one treatment option is associated with modulating at least one immune response component.

25. The method of claim 24, wherein one or more of the at least one immune response component comprises:
at least a part of one or more of an immune cell, a lymphoid cell, a myeloid cell, a T cell, a B cell, or a Natural Killer T Cell.

26. The method of claim 19, further comprising:
selecting one or more computable epitopes;
predicting at least one pattern change in the one or more computable epitopes;
associating the at least one pattern change in the one or more computable epitopes with at least one outcome; and
designating a course of action associated with the at least one pattern change in the one or more computable epitopes.

27. The method of claim 26, further comprising:
identifying at least one treatment option associated with the one or more computable epitopes.
